(19) United States
(12) Patent Application Publication
(10) Pub. No.: US 2021/0150565 A1
(43) Pub. Date: May 20, 2021

(54) METHOD AND APPARATUS FOR DIRECTING ACQUISITION OF INFORMATION IN A SOCIAL NETWORK

(71) Applicant: Affinio Inc., Halifax (CA)

(72) Inventors: Philip Joseph RENAUD, Toronto (CA); Maged E. Beshai, Maberly (CA)

(21) Appl. No.: 16/953,107

(22) Filed: Nov. 19, 2020

Related U.S. Application Data
(60) Provisional application No. 62/937,333, filed on Nov. 19, 2019.

(51) Int. Cl. G06Q 30/02; H04L 29/08

(52) U.S. Cl. CPC G06Q 30/0246; H04L 67/22; H04L 67/26

(57) ABSTRACT

Methods and apparatus for directing access to sources of information through an information dissemination network are disclosed. Upon detecting a user's access to a source, a recommendation to access a complementing source is communicated to the user. The recommendation is based on affinity measures for pairs of sources of information. Upon detecting the user's access transition to a new source of information within a predefined time interval, inter-source transition scores are recorded and new affinity levels of the current source to the new source are determined for each affinity measure. Affinity merits corresponding to affinity levels are determined based on tracking a population of users and determining users' compliance with recommendation. A complementing source is selected according to affinity merits corresponding to specific affinity levels of a current source to a set of sources.

### RELATED APPLICATIONS

The present application claims benefit from the U.S. provisional application, Ser. No. 62/937,333, filed on Nov. 19, 2019, the entire contents of which are incorporated herein by reference.

### FIELD OF THE INVENTION

The present invention relates to accessing information sources through an information dissemination system. In particular, the invention is directed to informing a user accessing a current information source of other complementing or comparable information sources.

### BACKGROUND OF THE INVENTION

A marketing system promoting a commodity or a service relies on knowledge of characteristics and traits of target consumers. Worldwide, a significant proportion of the population has access to, and regularly uses, social networks for information acquisition. The advent of software tools for detecting users' access to networks and tracking activities of individual users, together with respective accessed information, facilitates collection of valuable information which may be exploited for marketing purposes where the network users are viewed as the target consumers. There is a need, therefore, to explore means for real-time determination of appropriate information sources to recommend to active users.

### SUMMARY

In accordance with an aspect, the present invention provides a method of directing users' access to sources of information through an information dissemination network. Upon detecting a user's access to a source, a recommendation to access a complementing source is communicated to the user. The recommendation is based on affinity measures for pairs of sources of information of a set of sources of information.

The method comprises acquiring, for each source pair, inter-source affinity levels of a set of predefined affinity measures. Affinity merits corresponding to affinity levels are determined based on patterns of users' access to the sources. Initially, affinity merits of each source pair are set to equal respective affinity levels.

Upon detecting access of a user to a current source of information, a complementing source, selected according to affinity merits corresponding to specific affinity levels of the current source to a set of sources, is recommended to the user.

Upon detecting access transition of the user to a new source of information, inter-source transition scores are recorded. New affinity levels of the current source to the new source are determined for each affinity measure according to respective transition scores. Affinity merits for each affinity measure are then updated according to the respective transition scores.

To facilitate computation of affinity merits, the inter-source affinity levels corresponding to each affinity measure of the set of affinity measures are categorized into a respective number of affinity-level bands.

In accordance with an embodiment, the method comprises grouping the inter-source transition scores according to respective affinity-level bands. An affinity merit corresponding to each affinity-level band is determined as a ratio of a respective transition score to total transition score.

Alternatively, in accordance with another embodiment, the method comprises determining, for each affinity measure and a respective affinity-level band, a recommendation score, and—subject to a determination that the new source is the recommended source—a compliance score. An affinity merit is then determined as a ratio of a respective compliance score to a respective recommendation score.

In order to determine an affinity merit corresponding to an arbitrary affinity level, an interpolating function based on affinity merits corresponding to affinity-level bands is determined for each affinity measure.

### BRIEF DESCRIPTION OF THE DRAWINGS

Embodiments of the present invention will be further described with reference to the accompanying exemplary drawings, in which:

FIG. 1 illustrates methods of guiding social-network information acquisition, in accordance with an embodiment of the present invention;

FIG. 2 is an overview of a first method of guiding social-network information acquisition, in accordance with an embodiment of the present invention;

FIG. 3 is an overview of a second method of guiding social-network information acquisition, in accordance with an embodiment of the present invention;

FIG. 4 details the second method of guiding social-network information acquisition, in accordance with an embodiment of the present invention;

FIG. 5 illustrates a process, of the second method, of recommending an article transition, in accordance with an embodiment of the present invention;

FIG. 6 illustrates a process, of the second method, of determining user's response to recommendation, in accordance with an embodiment of the present invention;

FIG. 7 illustrates a first process of updating article-selection scores, in accordance with an embodiment of the present invention;

FIG. 8 illustrates a second process of updating article-selection scores, in accordance with an embodiment of the present invention;

FIG. 9 illustrates a universe of tracked users segmented into clusters based on characteristics of individual users;

FIG. 10 illustrates communities of users of the universe of tracked users defined according to respective user traits;

FIG. 11 illustrates superposition of communities onto clusters, for use in an embodiment of the present invention;

FIG. 12 illustrates requisite raw data (input data) for enabling identification of interrelated articles from among a massive collection of articles, analytic data extracted from the raw data, and distilled data indicating recommended articles to succeed each article, in accordance with an embodiment of the present invention;

FIG. 13 illustrates statistics of article-transition compliance ratio, for use in an embodiment of the present invention;

FIG. 14 illustrates division of levels of each of affinity measures into bands for capturing respective merit-defining article transitions;

FIG. 15 illustrates captured article-transition scores, for use in an embodiment of the present invention;

FIG. 16 illustrates cumulative article-transition scores and a respective interpolation function, for use in an embodiment of the present invention;

FIG. 17 illustrates captured transition scores for each affinity measure and corresponding merits determined according to the process of FIG. 7;

FIG. 18 illustrates merits of a specific affinity measure based on the article-transition scores of FIG. 17;

FIG. 19 illustrates compliance scores for each affinity measure determined according to the process of FIG. 8, in accordance with an embodiment of the present invention;

FIG. 20 illustrates noncompliance scores for each affinity measure determined according to the process of FIG. 8;

FIG. 21 illustrates merits for each affinity measure determined according to the process of FIG. 8, in accordance with an embodiment of the present invention;

FIG. 22 illustrates interpolated merits for each affinity measure determined according to the process of FIG. 8, in accordance with an embodiment of the present invention;

FIG. 23 illustrates compliance-ratio (merit) for different bands of similarity levels;

FIG. 24 illustrates a hypothetical case where compliance-ratio (merit) is independent of similarity levels;

FIG. 25 illustrates compliance-ratio (merit) for different bands of gravitation levels;

FIG. 26 illustrates compliance-ratio (merit) for different bands of attraction levels;

FIG. 27 illustrates compliance-ratio (merit) for different bands of interest levels;

FIG. 28 compares compliance ratios corresponding to different affinity measures for different affinity-level bands;

FIG. 29 illustrates affinity levels and corresponding affinity merit for different affinity measures;

FIG. 30 illustrates values of affinity measures corresponding to inter-article transition captured during a moving window of a predefined number of successive transitions, for use in an embodiment of the present invention;

FIG. 31 illustrates pairwise affinity-measures correlation, for use in an embodiment of the present invention;

FIG. 32 illustrates determining cross-correlation of any two variables over a moving window of N article-pair transitions, N>1, in accordance with an embodiment of the present invention;

FIG. 33 illustrates updating data for computing cross-correlation over the time window of FIG. 32;

FIG. 34 is a continuation of FIG. 34;

FIG. 35 illustrates a method for fast computation of cross-correlation of any two affinity measures, following each article transition, based on article-transition scores, in accordance with an embodiment of the present invention;

FIG. 36 illustrates a method for fast computation of cross-correlation of any two affinity measures, at spaced article transitions, based on article-transition scores, in accordance with an embodiment of the present invention;

FIG. 37 illustrates compliance ratio dependence on system's age and article-pair duration, for use in an embodiment of the present invention;

FIG. 38 illustrates an apparatus for directing acquisition of information, in accordance with an embodiment of the present invention;

FIG. 39 illustrates a method of directing article selection, in accordance with an embodiment of the present invention; and

FIG. 40 details a process of FIG. 39.

### TERMINOLOGY

Information tracking system: The term refers to apparatus and means for interaction with an information dissemination system to identify patterns of users' access to information
User: The term denotes a member of a population under consideration for developing a marketing system for specific commodities or for acquisition of data aiming at gaining insight for policy development. The population may include users of social media or respondents to surveys, among many other entities.
Characteristics of a user: The characteristics of a user represent slowly-varying properties (such as age or income), quasi-static properties (such as height of an adult), and/or permanent attributes such as place of birth. The characteristics of a user may comprise numerous attributes represented as a vector.
Traits of a user: The traits of a user represent evolving properties, such as societal views, favourite entertainment or sport, etc.
Cluster: A population under consideration may be segmented into a number of clusters according to values of a predefined set of characteristics for each member (user) of the population. The number of clusters may be predefined or determined automatically under specific constraints. A user may be characterized according to the user's affiliation with one of a predefined number of clusters and, possibly, the user's proximity to the centroid of the cluster.
Community: Members of the population (users) possessing a specific trait form a respective community. The number of communities equals the number of predefined traits of interest. A user belongs to a one cluster but may belong to numerous communities.
Article: The term refers to any computer readable file which may comprise a text, drawings, pictures, an audio signal, or a video signal. The term may refer to any information source, such as a website not just a file posted in a website.
Article access: The act of reading, viewing, or listening to an article is referenced as “article access” or “article inspection”.
Article transition: The act of successively accessing two articles within a predefined interval of time is referenced as “article transition” or simply “transition”.
Article succession: An article succession comprises two articles accessed by a same user
Article's metadata: When access to an article is detected, the system of the invention acquires information relevant to both the article and a network user accessing the article. The information may include an identifier of the article, data characterizing the article, an identifier of the user and data relevant to the user's characteristics and traits. The acquired information is collectively referenced as the article's metadata.
Article's characterization data: The term refers to content of an article and/or metadata of the article such as “author”, “language”, “topic”, “file-size”, etc. The topic may be one of predefined classifications such as art, sports, travel, cooking, politics, philosophy, history, computing, finances, etc.
Reference article: When a user accesses a first article then a second article, the first article is said to be the reference article.
Complementing article: An article perceived to provide information of interest to a user accessing a current article is referenced as a complementing article of the current article.
Usage data: Usage data comprises:
   identifiers of accessed articles and succession of articles accessed by a same user;
   an overall score of the number of transitions from a reference article to other articles;
   a cluster-specific score of the number of transitions from a reference article to other articles; and/or
   a trait-specific score of the number of transitions from a reference article to other articles.
Inter-article similarity level: The similarity level of two articles (information sources) is a measure of resemblance between the contents of the two articles or complementariness of the two articles where the two articles are of the same topic. Known techniques may be applied to determine a similarity measure of two files. For a collection of a large number of articles (tens of thousands, for example), content similarity may be assessed for an article pair only after inspecting the articles metadata; for example, there is no point in comparing lengthy contents of an article on cooking and an article on philosophy. Metadata comparison may also be appropriate for determining similarity between a lengthy text file and a video file containing few words; there would a high level of similarity between an article on the benefits of Yoga and a video recording of Yoga poses. Thus, a user who accesses a word article may be directed to an audio article or a video article, and vice versa.
Inter-article gravitation score: The term refers to a count of incidences of successive articles accessed by a same user regardless of the characteristics of the user.
Inter-article gravitation measure: The term refers to a measure based on a count (score) of the number of transitions from one article to another. A gravitation measure is independent of the types of users effecting the transitions.
Inter-article gravitation level: The term refers to a ratio of an inter-article gravitation score from a first article to a second article to the total number of transitions from the first article to all other articles.
Inter-article attraction score: The term refers to a count of transitions (incidences of successive articles accessed by a same user) for a specific cluster of users. The score may take into account proximity of descriptors of a user to descriptors of the centroid of a respective cluster.
Inter-article attraction level: The term refers to a ratio of an inter-article attraction score from a first article to a second article to the total number of transitions from the first article to all other articles effected by users of a same cluster.
Inter-article interest score: The term refers to a count of transitions (incidences of successive articles accessed by a same user) for users of a same community.
Inter-article interest measure: The term refers to a measure based on inter-article interest scores.
Composite affinity level: For a directed article pair and a specific user characteristic, a composite affinity level is determined as a function of the similarity level and the gravitation score of the article pair, as well as the attraction score which depends on the user's characteristics and the interest score which depends on the user's traits. Where the user's characteristics or traits are unknown, the composite affinity level is determined as a function of only the similarity level and the gravitation score of the article pair.
Measure of effective recommendations: The term refers to a value indicating effectiveness of recommendations, such as a proportion of transitions obeying recommendations or a (positive) change in mean value of a composite measure of affinity.
Merit of an affinity measure: The merit of any of the affinity measures (similarity, gravitation, attraction, or interest) is defined as either a proportion of article transitions corresponding to a respective value of an affinity measure, or users' compliance to recommendations corresponding to a respective value of an affinity measure.
Randomly sequenced round robin process: The term refers to selecting items from different sets in a random order.
system age: The time period since the start of tracking users is referenced as “system age”.
Concurrence period: The term “concurrence period” (or “simultaneity period”) refers to a time period during which two articles have been available for user access.

### REFERENCE NUMERALS

100: Methods of guiding social-network information acquisition
110: Process of detecting user's access to an article
120: Process of selecting an article of significant affinity based on values of multiple affinity measures
140: Process of selecting an article of significant affinity based on merits of multiple affinity measures
150: Process of determining a merit of an affinity measure based on a proportion of article transitions
160: Process of determining a merit of an affinity measure based on compliance to recommendation
170: Process of determining a favorite succeeding article and communicating respective information to user
200: Overview of a first method of guiding social-network information acquisition
210: Process of monitoring article transitions
220: Process of determining article-pair affinity levels, for each affinity measure
230: Process of selecting, and communicating, a successor article based on article-pair affinity level
300: Overview of a second method of guiding social-network information acquisition
330: Process of determining an article-pair merit for each affinity measure
340: Process of selecting, and communicating, a successor article based on article-pair merits
400: Details of second method of guiding social-network information acquisition
410: Processes of initializing an array of tuples for each affinity measure (pre-processing stage)
420: Process of detecting a current-user's access to an article
430: Process of acquiring information relevant to article and user
440: Process of determining article-pair affinity levels for each predefined affinity measure
450: Process of determining a merit value for each affinity measure
460: Process of determining, and communicating, a succeeding article based on article-pair merit values
470: Process of determining response to recommendation
510: Process of identifying a set of candidate articles of significant affinity to a current article
520: Process of evaluating each candidate article
530: Process of determining an affinity merit for each of predefined affinity measures
540: Process of determining a composite affinity merit
550: Process of performing a weighted random selection to determine a recommended article
620: Process of receiving an identifier of a recommended article
630: Process of monitoring user's action over a prescribed time window
640: Process of determining whether the user accessed another article within the time window
650: Process of identifying a selected article
660: Process of updating a score of article transition
700: Process of updating article-selection scores (relevant to process 150)
710: Process of determining affinity levels for different affinity measures corresponding to an article transition
720: Process of determining a merit value for a selected affinity parameter
730: Process of identifying a specific tuple corresponding to the selected affinity parameter
740: Process of increasing current score stored in an element of the specific tuple
750: Process of computing a merit value corresponding to the affinity parameter as a proportion of all article transitions from a reference article
760: Process of updating a merit vector corresponding to the selected affinity parameter
800: Process of updating article-selection scores (relevant to process 160)
810: Process of determining affinity levels of different affinity measures corresponding to an article transition
820: Process of determining a merit value for a selected affinity measure
830: Process of identifying a tuple corresponding to selected affinity measure
840: Process of ascertaining user's compliance with recommendation
850: Process of increasing current score stored in a first element of the specific tuple
860: Process of increasing current score stored in a second element of the specific tuple
870: Process of computing a merit value corresponding to the affinity parameter as a compliance ratio
880: Process of updating a merit vector corresponding to the selected affinity parameter
900: Clusters of users formed according to characteristics of individual users
920: Universe of tracked users
1000: Communities of users formed according to traits of individual users
1020: A community of users corresponding to a single trait
1100: Superposition of communities onto clusters
1200: Data required for determining harmonious article succession
1210: Article characterization data including articles' metadata and content storage address or network address for retrieving articles' contents
1220: Usage data including identifiers of accessed articles and succession of articles accessed by a same user
1225: Active-users' registry structured to identify users accessing an article during a moving time window or a window of a predefined number of most recently tracked users' access to articles
1230: Users' characterization data including identifiers of clusters of users
1240: Users' traits data including identifiers of communities of users
1250: Inter-article similarity levels based on comparing articles' contents
1260: Inter-article gravitation data based on tracking successive articles accessed by a same user regardless of the characteristics of the user
1270: Inter-article attraction data based on tracking successive articles accessed by a same user taking into account the user's affiliation such as a cluster to which the user belongs and proximity of descriptors of the user to descriptors of the centroid of the cluster
1280: Inter-article interest data based on tracking successive articles accessed by a same user taking into account the user's communities
1290: Composite affinity coefficients for directed article pairs
1300: Exemplary statistics of article-transition compliance ratio
1320: Collection of article pairs
1321: First set of article pairs
1322: Second set of article pairs
1323: Third set of article pairs
1324: Fourth set of article pairs
1340: Mean number of article recommendations per compliance
1350: Zone of autonomous transitions and/or effective recommendations
1360: Zone of ineffective recommendations
1400: Division of levels of each of affinity measures into respective bands
1410: Normalized affinity measure value (any affinity measure)
1420: Band of levels of similarity
1430: Band of levels of gravitation
1440: Band of levels attraction
1450: Band of levels of interest
1500: Captured article-transition scores
1510: Level of one of the affinity measures
1520: Transition score
1530: Cumulative transitions for a hypothetical case where article transition is independent of an affinity measure
1540: Cumulative transitions
1550: Interpolated cumulative transitions based on individual transitions
1560a: Number of transitions during a parameter band
1560b: Number of transitions during another parameter band
1600: Cumulative article-transition scores
1660a: Cumulative transitions during a parameter band
1660b: Cumulative transitions during another parameter band
1670: Interpolated cumulative transitions based on transition-count for parameter bands
1700: Captured transition scores for each affinity measure
1710: Index of similarity band
1712: Article-transition scores corresponding to similarity bands
1714: Proportion of article-transitions corresponding to similarity bands
1720: Index of gravitation band
1722: Article-transition scores corresponding to gravitation bands
1724: Proportion of article-transitions corresponding to gravitation bands
1730: Index of attraction band
1732: Article-transition scores corresponding to attraction bands
1734: Proportion of article-transitions corresponding to attraction bands
1740: Index of interest band
1742: Article-transition scores corresponding to interest bands
1744: Proportion of article-transitions corresponding to interest bands
1800: Merits of a specific affinity measure based on the article-transition scores
1810: Similarity values
1820: Proportion of inter-article transitions
1830: Similarity merit for a specific similarity band based on the article-transition scores
1840: Interpolated similarity merits
1900: Compliance scores for each affinity measure
1912: Compliance scores corresponding to similarity bands
1914: Increment of compliance score corresponding to a respective similarity band
1922: Compliance scores corresponding to gravitation bands
1924: Increment of compliance score corresponding to a respective gravitation band
1932: Compliance scores corresponding to attraction bands
1934: Increment of compliance score corresponding to a respective attraction band
1942: Compliance scores corresponding to interest bands
1944: Increment of compliance score corresponding to a respective interest band
2000: Noncompliance scores for each affinity measure
2012: Noncompliance scores corresponding to similarity bands
1914: Increment of compliance score corresponding to a respective similarity band
2022: Noncompliance scores corresponding to gravitation bands
2024: Increment of compliance score corresponding to a respective gravitation band
2032: Noncompliance scores corresponding to attraction bands
2034: Increment of noncompliance score corresponding to a respective attraction band
2042: Noncompliance scores corresponding to interest bands
2044: Increment of noncompliance score corresponding to a respective interest band
2100: Merits for each affinity measure based on compliance
2112: Similarity merit corresponding to a similarity band
2114: Computation of similarity merit.
2122: Gravitation merit corresponding to a gravitation band
2114: Computation of gravitation merit.
2132: Attraction merit corresponding to an attraction band
2114: Computation of attraction merit.
2142: Interest merit corresponding to an interest band
2144: Computation of interest merit.
2200: Interpolated merits for each affinity measure
2205: Normalized values of affinity measure
2210: Similarity-merit vector
2214: Similarity merit corresponding to a similarity value
2220: Gravitation-merit vector
2224: Gravitation merit corresponding to a gravitation value
2230: Attraction-merit vector
2234: Attraction merit corresponding to an attraction value
2240: Interest-merit vector
2244: Interest merit corresponding to an interest value
2300: Compliance-ratio (merit) for different bands of similarity levels
2310: Similarity level
2320: Score of recommended articles and selected articles
2330: Compliance ratio
2340: Score of recommended articles corresponding to a respective similarity band
2350: Score of selected articles corresponding to a respective similarity band
2360: Similarity merit corresponding to a respective similarity band
2370: Interpolated similarity merit for an arbitrary similarity level
2400: Hypothetical independence of compliance-ratio (merit) from similarity levels
2440: Score of recommended articles corresponding to a respective similarity band
2450: Score of selected articles corresponding to a respective similarity band
2460: Hypothetical similarity merit corresponding to a respective similarity band
2500: Compliance-ratio (merit) for different bands of gravitation levels
2510: Gravitation level
2540: Score of recommended articles corresponding to a respective gravitation band
2550: Score of selected articles corresponding to a respective gravitation band
2560: Gravitation merit corresponding to a respective gravitation band
2570: Interpolated gravitation merit for an arbitrary similarity level
2600: Compliance-ratio (merit) for different bands of attraction levels
2610: Attraction levels
2640: Score of recommended articles corresponding to a respective attraction band
2650: Score of selected articles corresponding to a respective attraction band
2660: Attraction merit corresponding to a respective attraction band
2670: Interpolated attraction merit for an arbitrary attraction level
2700: Compliance-ratio (merit) for different bands of interest levels
2710: Interest levels
2740: Score of recommended articles corresponding to a respective interest band
2750: Score of selected articles corresponding to a respective interest band
2760: Attraction merit corresponding to a respective interest band
2770: Interpolated attraction merit for an arbitrary interest level
2800: Comparison of compliance ratios corresponding to different affinity measures for different affinity-level bands
2810: Affinity levels for any of four affinity measures
2910: Reference article
2920: Candidate articles for recommendation to a user
2930: A composite affinity level based on affinity levels of the four affinity measures
2940: A composite affinity level based on affinity merits of the four affinity measures
3000: Affinity measures corresponding to a moving window of a predefined number of transitions.
3010: Affinity measure type
3020: Index of buffer cell
3040: Similarity level of successively accessed articles of a particular transition
3050: Gravitation level of successively accessed articles of a particular transition
3060: Attraction level of successively accessed articles of a particular transition
3070: Interest level of successively accessed articles of a particular transition
3080: Insertion of newest data to overwrite oldest data in a circular buffer
3100: Pairwise affinity-measures correlation
3102: Recommendations count
3104: Correlation coefficient
3110: Gravitation-interest correlation
3120: Similarity-gravitation correlation
3130: gravitation-attraction correlation
3140: Attraction-interest correlation
3150: Similarity-attraction correlation
3160: Similarity-interest correlation
3200: Cross-correlation of any two variables over a moving window of article-pair transitions
3210: Array of N Tuples, N>1
3220: Tuple corresponding to a respective event
3230: Expression for determining cross-correlation of two variables u and v
3240: Expression, derived from expression 3230, for recursively determining cross-correlation of the two variables u and v for values of u and v within a moving window.
3300: Process of updating window data
3310: Buffer-cell indices
3320: Zero-initialized buffer cells
3321: Tuple elements holding similarity levels
3322: Tuple elements holding gravitation levels
3330: Transition indices
3400: Process of updating window data—continued
3500: Method for fast computation of cross-correlation of any two affinity measures, following each article transition
3510: Process of work-arrays initialization
3520: Process of receiving, retaining, and updating records of tracked data
3530: Process of defining window boundaries
3540: Process of updating cumulative data
3550: Process of computing a correlation coefficient
3600: Method for fast computation of cross-correlation of any two affinity measures, at spaced article transitions
3645: Process of spacing correlation-coefficient computations
3700: Compliance ratio dependence on system's age and article-pair duration
3710: System age or article-pair coincidence period
3720: Compliance ratio corresponding to age or coincidence period
3730: Compliance ratio versus system age
3740: Compliance ratio versus coincidence period—case-1
3750: Compliance ratio versus coincidence period—case-2
3760: Compliance ratio versus coincidence period—case-3
3800: Apparatus for tracking users and identifying a user's access to an article
3802: Current article
3804: Recommended article
3810: Tracking module
3820: Assembly of processors
3832: A memory device storing data relevant to information sources (articles)
3834: A memory device storing data relevant to clusters of users formed according to users' characteristics
3836: A memory device storing data relevant to users' communities formed according to users' traits
3842: Memory device storing similarity levels of article-pairs (pairs of information sources). A similarity vector of a specific article indicates a similarity level to each other article of a similarity level exceeding a prescribed value.
3844: Memory device storing a gravitation vector for each article. A gravitation vector of a specific article indicates a gravitation level to each other article of a gravitation level exceeding a prescribed value.
3846: Memory device storing an attraction vector for each article. An attraction vector of a specific article indicates an attraction level to each other article where the attraction level exceeds a prescribed value.
3848: Memory device storing an interest vector for each article. An interest vector of a specific article indicates an interest level relevant to each other article where the interest level exceeds a prescribed value.
3880: Memory devices storing software modules
3881: A memory device storing a software module for determining an appropriate information source (an appropriate article) to follow a currently accessed information source or article
3882: A memory device storing a software module for determining users' compliance scores
3883: Memory device storing software modules for updating mutual similarity levels of information sources or articles
3884: Memory device storing software modules for updating mutual gravitation levels of information sources or articles
3885: Memory device storing software modules for updating mutual attraction levels of information sources or articles
3886: Memory device storing software modules for updating mutual interest levels of information sources or articles
3900: Method of directing article selection
3910: Process of initializing inter-article affinity levels and affinity merits for each affinity measure
3920: Process of detecting user's access to a current article
3930: Process of recommending a complementing article to follow the current article based on respective affinity merits of a set of candidate complementing articles
3940: Process of detecting transition to a new article within a predefined time interval
3950: Process of updating inter-article transition scores
3960: Process of updating inter-article affinity level for each affinity measure
3970: Process of determining affinity merits corresponding to respective affinity levels
4020: Processes of determining affinity merits for a single affinity measure
4030: process of determining a specific affinity band of a specific affinity measure for a specific affinity level
4035: Process of selecting a method of determining affinity merits
4040: Process of increasing transition score for the specific affinity band determined in process 4030
4050: Process of determining an affinity merit corresponding to the specific affinity band as a ratio of the transition score of the specific affinity band to the total transition score
4055: Process of selecting process 4060 if the new article is not the recommended complementing article or process 4070 inn the case of compliance (the new article being the complementing article)
4060: Process of increasing a noncompliance score corresponding to the specific affinity band
4070: Process of increasing a compliance score corresponding to the specific affinity band
4080: Process of determining an affinity merit corresponding to the specific affinity band as a ratio of the compliance score to the sum of compliance score and noncompliance score

### DETAILED DESCRIPTION

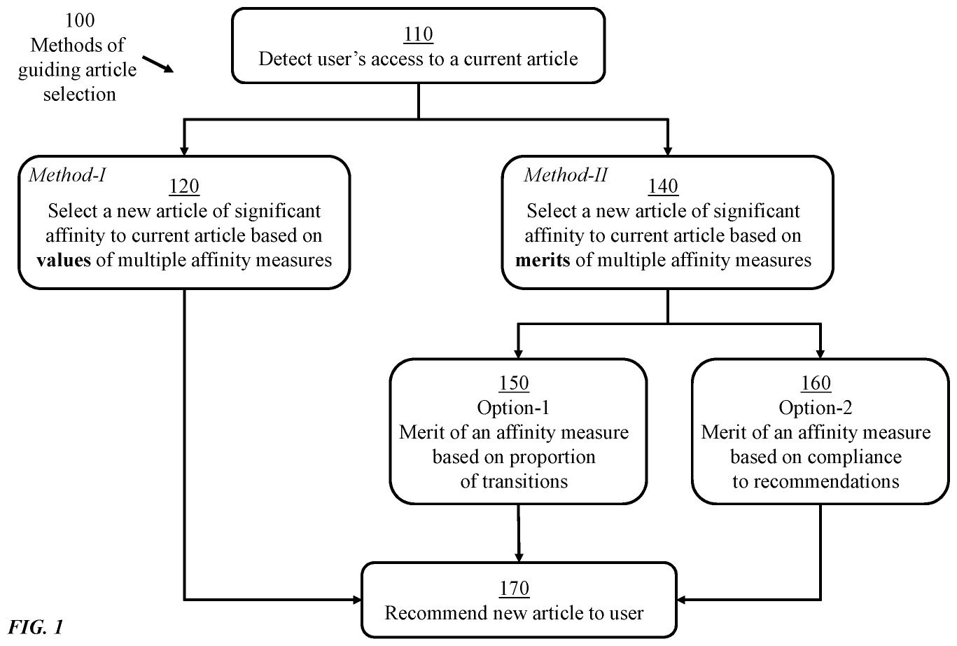

FIG. 1 illustrates methods 100 of guiding social-network information acquisition. According to a first method (method-I), upon detecting user's access to a current article (process 110), a new article of significant affinity to the current article is selected (process 120) based on levels of predefined affinity measures. The affinity measures include similarity, gravitation, attraction, and interest. According to a second method (method-II), upon detecting user's access to a current article (process 110), a new article of significant affinity to the current article is selected (process 140) based on merits of the multiple affinity measures. The merit of an affinity measure may be determined (process 150) based on a proportion of article transitions (option-1). Alternatively, the merit of an affinity measure may be determined (process 160) based on users' compliance to recommendations (option-2).

The new article selected according to method-I, option-1 of method-II, or option-2 of method-II is recommended to the user (process 170).

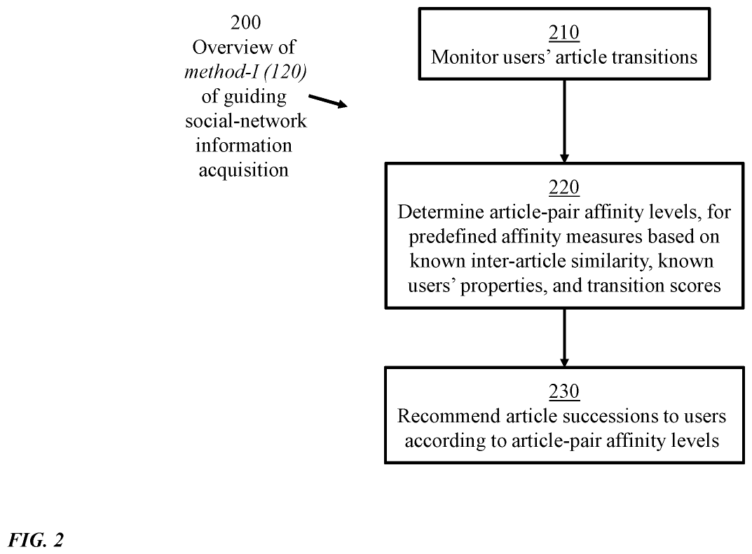

FIG. 2 illustrates basic processes 200 of method-I of guiding social-network information acquisition. Process 210 receives information relevant to a user accessing successive articles (i.e., article transitions). Process 220 determines article-pair affinity levels for the predefined affinity measures based on known inter-article similarity levels, known users' properties, and current scores of tracked article transitions. Upon detecting users' access to articles, complementing articles to succeed currently accessed articles are determined and relevant data are communicated to respective users.

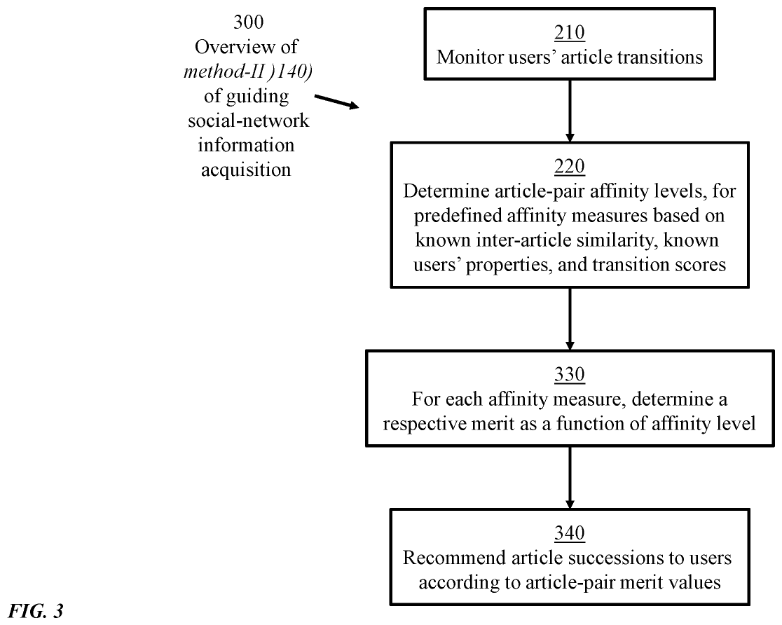

FIG. 3 illustrates basic processes 300 of the second method of guiding social-network information acquisition. Processes 210 and 220 are as described above with reference to FIG. 2. Process 330 determines an article-pair merit corresponding to an affinity level for each affinity measure. Process 340 selects and communicates a successor article based on merit.

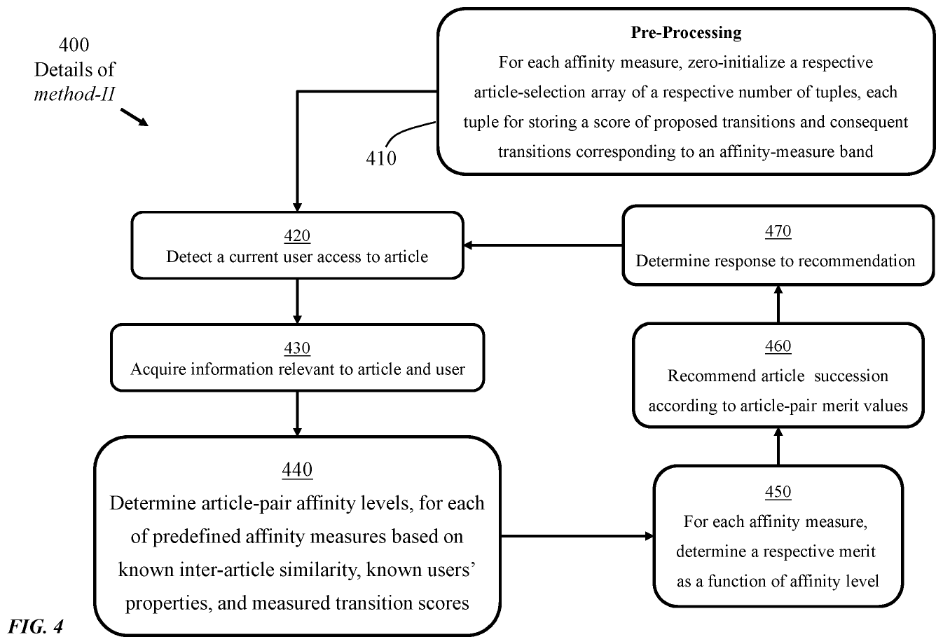

FIG. 4 illustrates constituent processes 400 of the second method (Method-II) of guiding social-network information acquisition. In a pre-processing stage 410, an array of tuples for each affinity measure, together with relevant variables, are initialized. Process 420 receives data relevant to a current-user's access to an article. Process 430 acquires information relevant to article and user. Process 440 determines article-pair affinity levels for each predefined affinity measure. Process 450 determines a merit value for each affinity measure. Process 460 determines a complementing article, based on article-pair merit values, and communicates relevant information to a respective user. Process 470 detects user's response to recommendation.

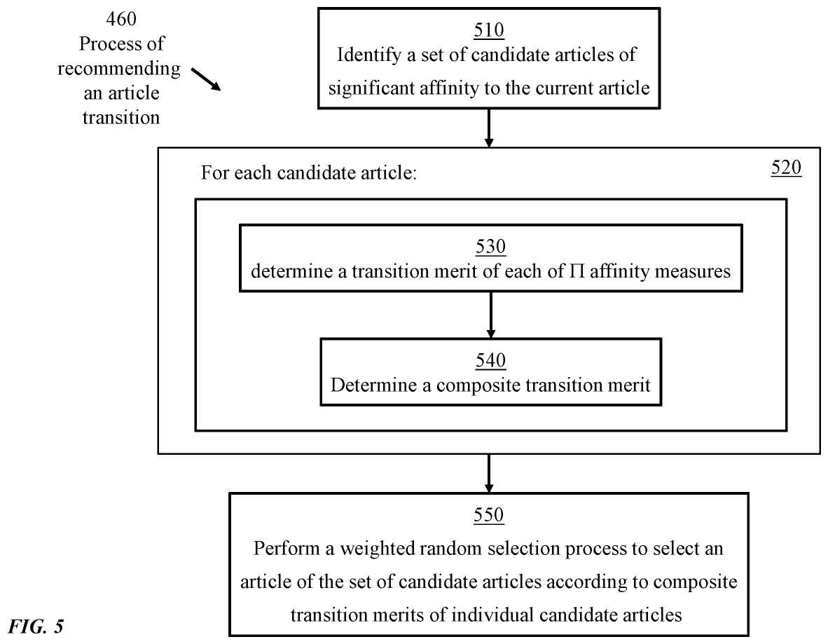

FIG. 5 details process 460 of FIG. 4. Process 510 identifies a set of candidate articles of significant affinity to a current article. Process 520, which comprises processes 530 and 540, evaluates each candidate article. Process 530 determines an affinity merit for each of predefined affinity measures. Process 540 determines a composite affinity merit. Process 550 performs a weighted random selection to determine a recommended article.

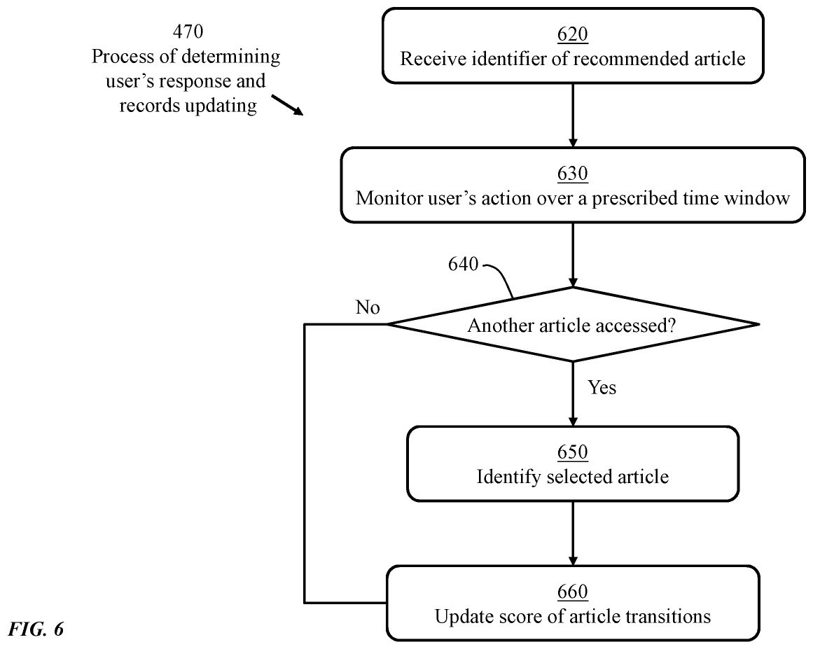

FIG. 6 illustrates process 470 of FIG. 4. Process 620 receives an identifier of a recommended article. Process 630 monitors user's action over a prescribed time window. Process 640 determines whether the user accessed another article within the time window. Process 650 identifies user's selected article. Process 660 updates a score of article transition.

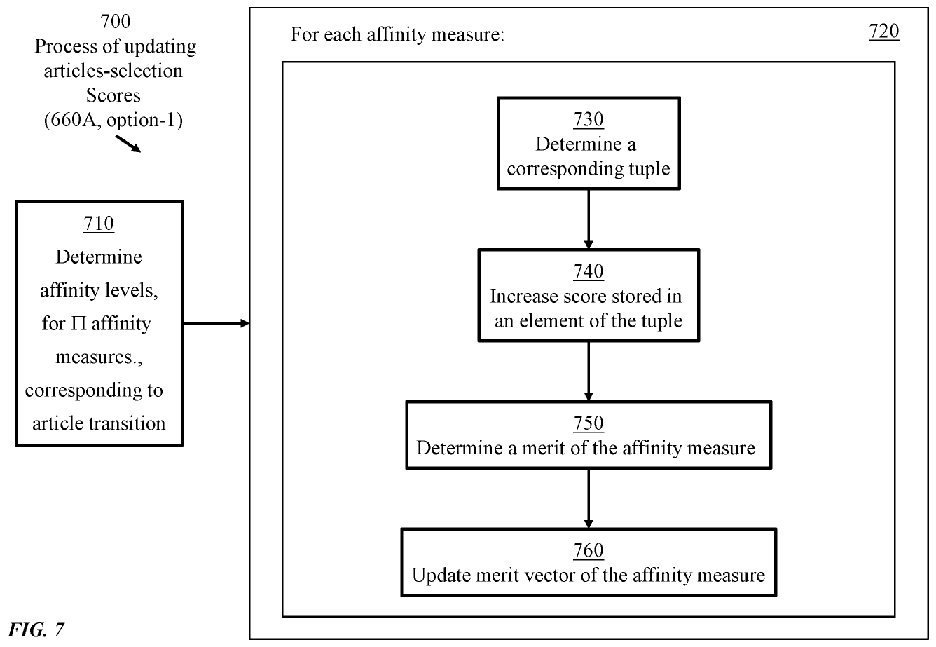

FIG. 7 illustrates constituent processes 700 of process 660 (FIG. 6) of updating article-selection scores relevant to process 150 of FIG. 1, corresponding to Option-1 of Method-II. Process 710 determines affinity levels of different affinity measures corresponding to an article transition. Process 720 determines a merit value for a selected affinity measure. Process 730 identifies a specific tuple corresponding to the selected affinity measure. Process 740 increases a current score stored in an element of the specific tuple. Process 750 computes a merit value corresponding to the affinity measure as a proportion of all article transitions from a reference article. Process 760 updates a merit vector corresponding to the selected affinity measure.

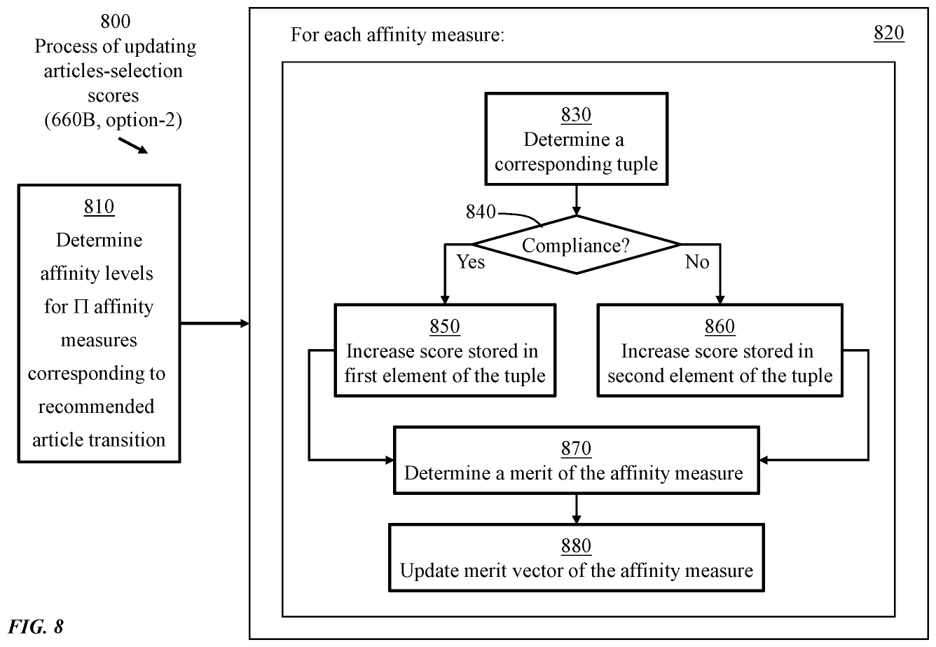

FIG. 8 illustrates constituent processes 800 of process 660 (FIG. 6) of updating article-selection scores relevant to process 160 of FIG. 1, corresponding to Option-2 of Method-II. Process 810 determines affinity levels of different affinity measures corresponding to an article transition. Process 820 determines a merit value for a selected affinity measure. Process 840 ascertains user's compliance with a recommendation. Process 850 increases a current score stored in a first element of the specific tuple in a case of compliance. Process 860 increases a current score stored in a second element of the specific tuple in a case of noncompliance. Process 870 computes a merit value corresponding to the affinity parameter as a compliance ratio determined as a ratio of a compliant-transition score corresponding to a recommendation score. Process 880 updates a merit vector corresponding to the selected affinity measure of process 820.

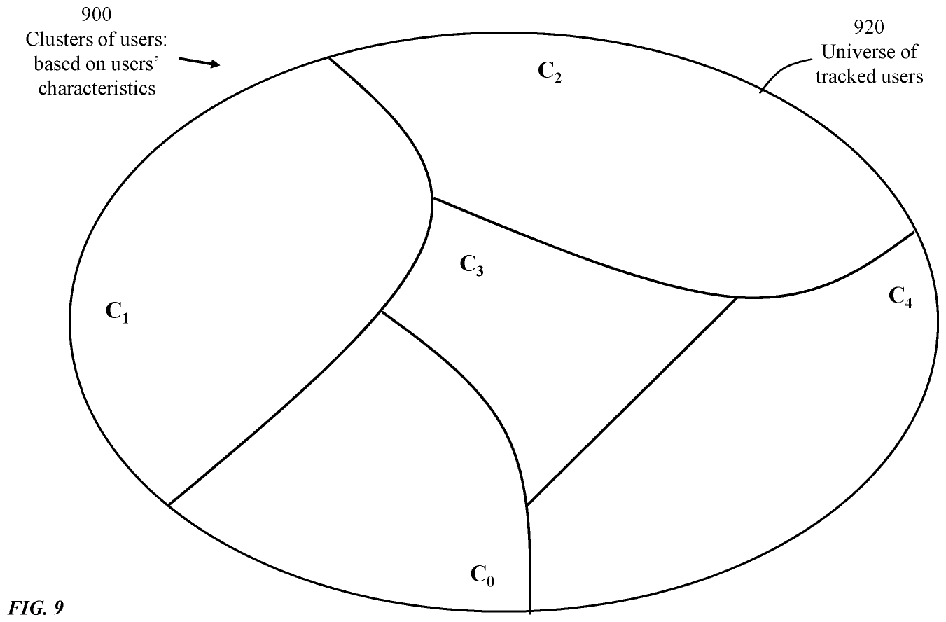

FIG. 9 illustrates a universe 920 of tracked users segmented into clusters 900 based on characteristics of individual users. Five clusters, labelled C₁ to C₅ are illustrated. Each user of the universe of tracked users belongs to only one cluster.

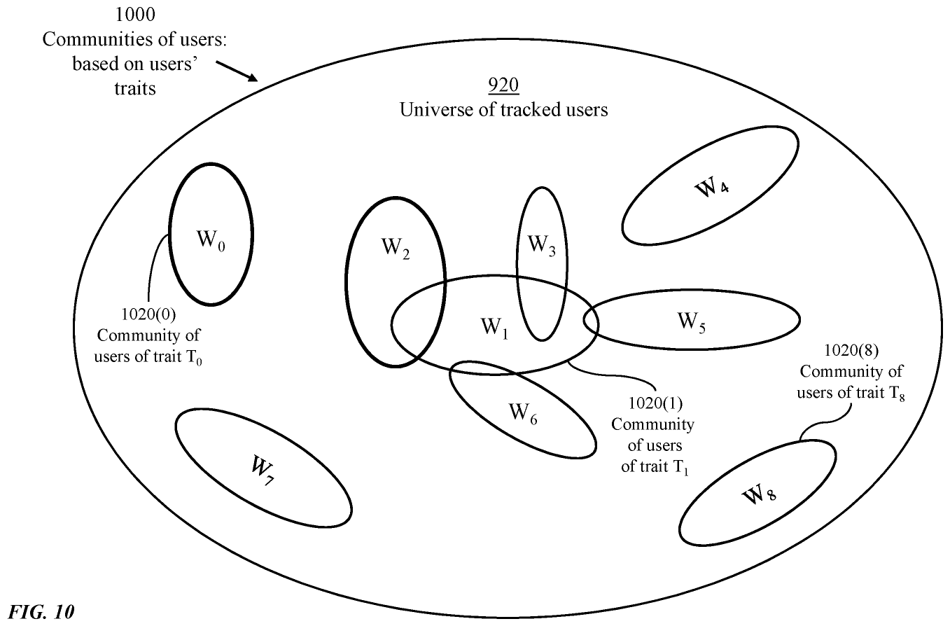

FIG. 10 illustrates communities 1000 of users of the universe of tracked users formed according to traits of individual users. A community 1020 of users corresponds to a single trait. Nine communities, labeled W₀ to W₈, are illustrated. Each community corresponds to a single trait. A user may have more than one trait. Thus, a community may intersect other communities; for example, community W₁ intersects each of communities W₂, W₃, W₅, and W₆.

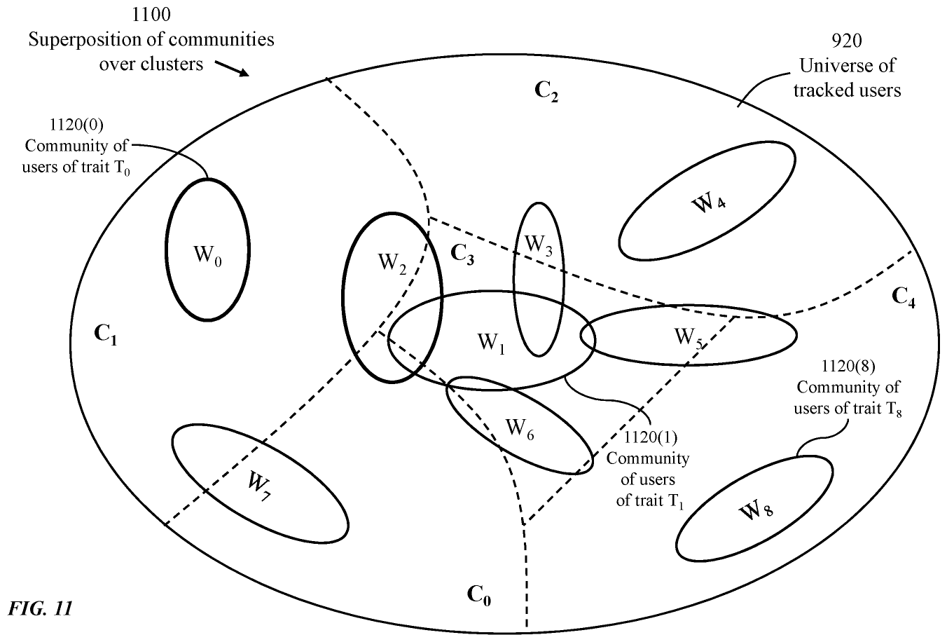

FIG. 11 illustrates superposition 1100 of the communities W₀ to W₈, onto clusters C₀ to C₄ indicating saturation of the communities within the clusters. As illustrated, some members (users) of community W₁ belong to cluster C₃ while the remaining members of community W₁ belong to cluster C₀. Community W₂ includes members belonging to cluster C₀, members belonging to cluster C₁, and members belonging to cluster C₃.

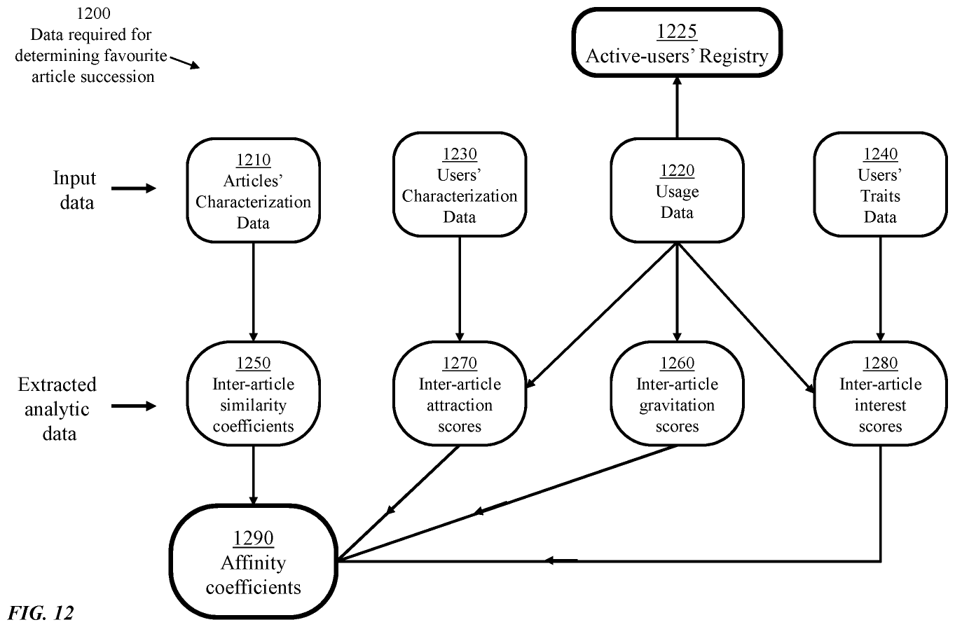

FIG. 12 illustrates data 1200 required for determining recommended article succession. Raw data 1210, 1220, 1230, and 1240 enables identification of interrelated articles from among a massive collection of articles. Article characterization data 1210 comprises articles' metadata and content-storage addresses or network addresses for retrieving articles' contents. Usage data 1220 comprises identifiers of accessed articles and succession of articles accessed by a same user. An active-users' registry 1225 is structured to identify users accessing an article during a moving time window or a moving window of a predefined number of most recently tracked users. Users' characterization data 1230 comprises identifiers of clusters of users. Users' traits data 1240 comprises identifiers of communities of users.

Inter-article similarity levels 1250 are determined from article characterization data 1210 based on comparing articles' contents. Inter-article gravitation scores 1260 are determined from usage data 1220 based on tracking successive articles accessed by a same user regardless of the characteristics of the user. Inter-article attraction scores 1270 are determined from usage data 1220 based on tracking successive articles accessed by a same user taking into account the user's affiliation such as a cluster to which the user belongs and proximity of descriptors of the user to descriptors of the centroid of the cluster. Inter-article interest scores 1280 are determined from usage data 1220 based on tracking successive articles accessed by a same user taking into account the user's membership of communities. Composite affinity coefficients 1290 are determined according to similarity levels 1250, gravitation scores 1260, attraction scores 1270, and interest scores 1280.

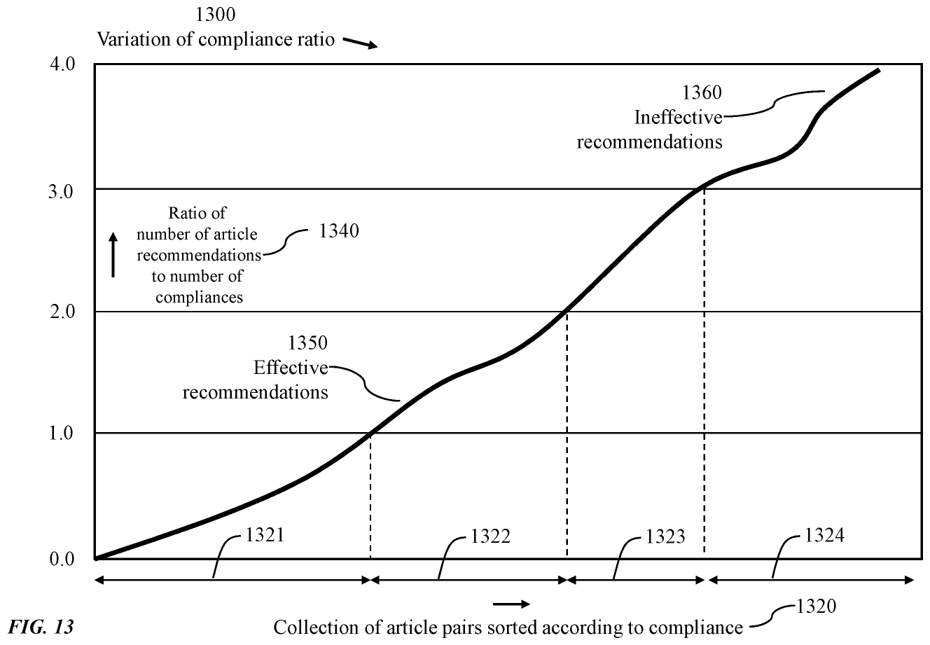

FIG. 13 illustrates variation 1300 of article-transition compliance ratio for a collection 1320 of sorted tracked transitions. Generally, transition from a first article to a second article may take place spontaneously or in response to a recommendation. For a first set 1321 of article pairs, the mean number 1340 of article recommendations per compliance is between 0.0 and 1.0. For a second set 1322 of article pairs, the mean number 1340 of article recommendations per compliance is between 1.0 and 2.0, and so on for the third set 1323 and the fourth set 1324. The users' responses to transition recommendations may vary significantly, in which case it is useful to establish a relationship between values of the measures upon which a recommendation is made and respective user's compliance. A method of recommending the second article to succeed the first article, according to the present invention, is based on levels of affinity measures of the first article and second article.

The objective is to guide a social-network user observing a specific article to switch to another article having a high affinity to the specific article. There may be numerous factors that influence the user's article selection. One of the factors conjectured to be effective is the inter-article similarity which may be based on content similarity. Another factor may be based on author's or advertiser's attributes.

Four affinity measures are considered for recommending an inter-article transition: (1) articles' similarity; (2), historical transition patterns of the entire population of users (gravitation); (3) historical transition patterns of users of same characteristics (attraction); and (4) historical transition patterns of users of the same traits.

Inter-article similarity levels are determined a priori. Inter-article transition patterns of users of the entire population of users define a gravitation measure. Thus, if a significant number of users has switched to article x₁, after observing article x or any article of type y, then article xi would be considered a good candidate for transition from article x or any article of type y. Alternatively, if article x is of article type y, and if a significant number of users accessing articles of type y has switched to articles of type y₁, then any article of type y₁ would be considered a candidate for recommendation to access after accessing article x.

Inter-article transition patterns of users of the same cluster of users define an attraction measure. Thus, if a specific user is currently observing an article x of article type y, and a significant proportion of users belonging to the specific-user's cluster has switched to article x₁ of type y₁, after observing article x or any article of type y, then article x₁ or any article of type y₁, is considered a candidate for recommendation.

Inter-article transition patterns of users of the same traits define an interest measure. Thus, if a specific user is currently observing an article x of article type y, and a significant proportion of users having common traits with those of the specific user has switched to article x₁ of type y₁, after observing article x or any article of type y, then article x₁ or any article of type y₁, would be considered a candidate for recommendation.

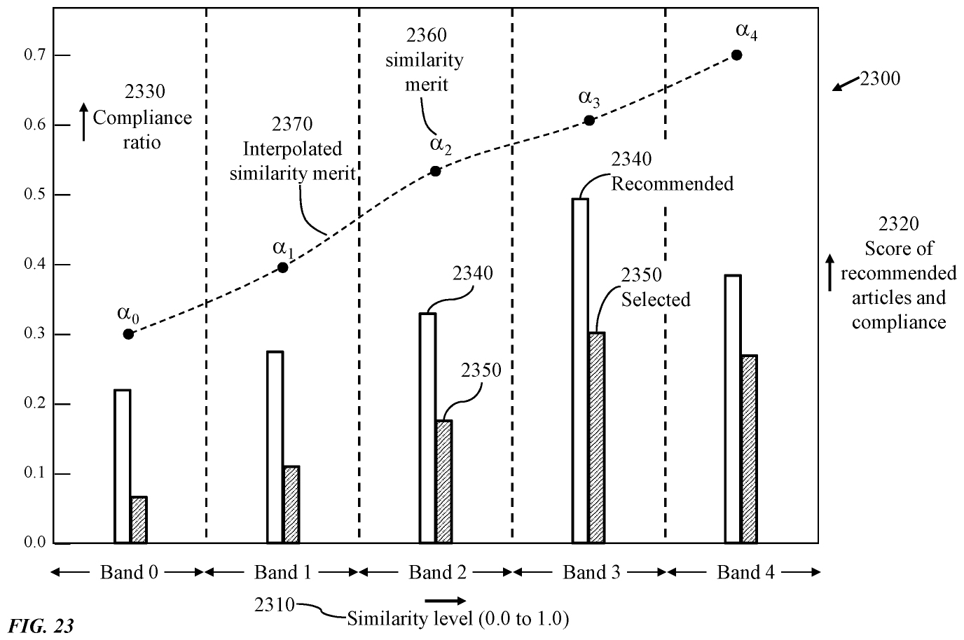

Article selection is based on a composite affinity level based on similarity, gravitation, attraction, and interest. To evaluate the effectiveness of the method, users' compliance ratios over a moving window of a predefined number of transitions are determined, as illustrated in FIGS. 23 to 28, and correlated with corresponding affinity levels of each of the four affinity measures for the purpose of determining the actual significance of each of the affinity measures.

For example, common traits of users accessing a specific article and users accessing a candidate article may determine the likelihood of a user selecting the candidate article following the specific article. A user may belong to one cluster but multiple trait communities. The intersection levels of trait communities of users who accessed an article x₁ and trait communities of users who have accessed an article x₂ may determine the likelihood of selecting article x₂ to follow article x₁. The same applies when article types, rather than specific articles, are considered.

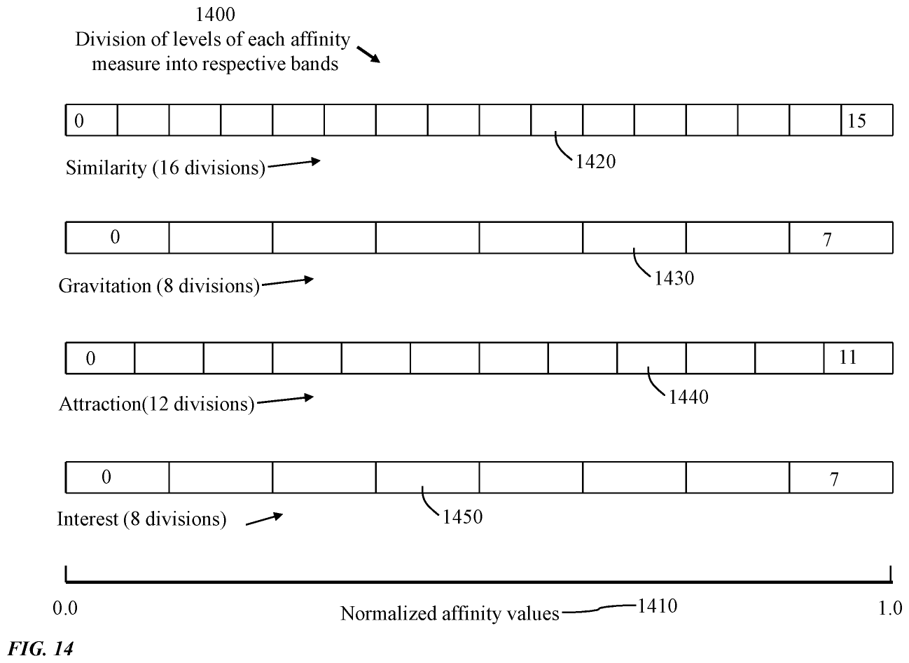

FIG. 14 illustrates division 1400 of values of each of affinity measures into bands for capturing respective merit-defining article transitions. Each of the affinity measures is normalized (reference 1410). The number of bands of the four affinity measures may be selected according to perceived (or measured) compliance sensitivity to individual affinity measures. For example, the similarity measure may be divided into 16 bands 1420, the gravitation measure may be divided into 8 bands 1430, the attraction measure may be divided into 12 bands 1440, and the interest measure may be divided into 8 bands 1450.

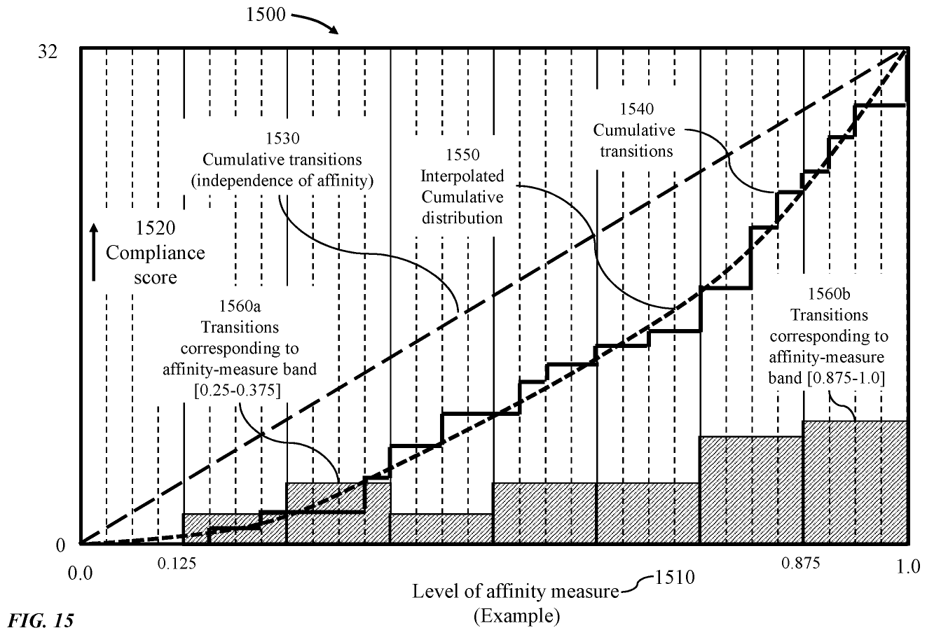

FIG. 15 illustrates exemplary variation 1500 of the compliance score with the level of an affinity measure. The compliance score 1520, which is captured article-transition scores following recommendations, depends on the level 1510 of an affinity measure (similarity, for example). In a hypothetical case where the compliance score is independent of the value of the affinity measure, the cumulative score of transitions would have a linear relationship 1530 to the value of the affinity measure. It is anticipated, however, that probability of compliance increases as the values of the affinity measure increases. A typical cumulative transition score 1540 may be determined for (sorted) ascending values of the affinity measure. An interpolated cumulative compliance score 1550 may be derived for use in determining expected compliance score for arbitrary values of the affinity measure.

A practical method of tracking compliance scores is to determine compliance count per affinity-measure band. For example, the number of transitions 1560a corresponds to band {0.250-0.375) of the normalized affinity measure and the number of transitions 1560b corresponds to band {0.875-1.0) of the normalized affinity measure.

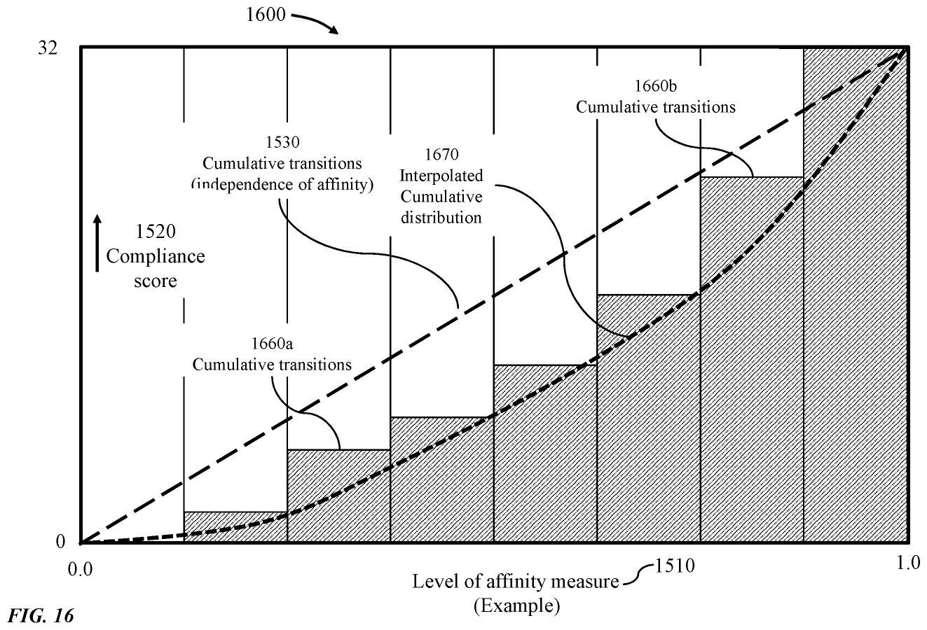

FIG. 16 illustrates cumulative article transition score 1600. The cumulative compliance score 1660 is determined from compliance count per band of the affinity measure (FIG. 15). For example, the cumulative number of transitions 1660a and 1660b correspond to values of normalized affinity measures of 0.375 and 1.0, respectively. A respective interpolation function 1670 may be used to estimate compliance corresponding to an arbitrary affinity level.

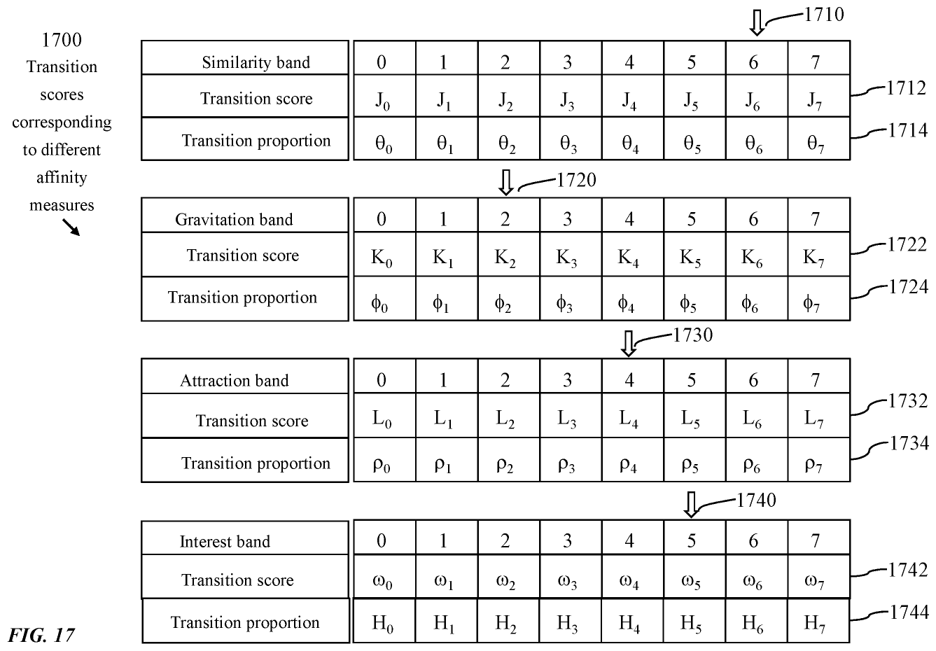

FIG. 17 illustrates captured transition scores 1700 for each affinity measure and corresponding merits determined according to the process of FIG. 7. The number of bands for each affinity measure is selected to be the same (eight) for ease of illustration. The transition scores corresponding to the bands of the similarity measure are denoted J₀, J₁, . . ., J₇ (reference 1712). The transition scores corresponding to the bands of the gravitation measure are denoted K₀, K₁, . . . , K₇ (reference 1722). The transition scores corresponding to the bands of the attraction measure are denoted L₀, L₁, . . . , L₇ (reference 1732). The transition scores corresponding to the bands of the interest measure are denoted H₀, H₁, . . . , H₇ (reference 1742)

The transition proportion corresponding to the bands of the similarity measure are denoted θ₀, θ₁, . . . , θ₇ (reference 1714), where θₜ=Jₜ/(J₀+J₁, . . . +J₇), 0≤t<8.

The transition proportion corresponding to the bands of the gravitation measure are denoted ϕ₀, ϕ₁, . . . , ϕ₇ (reference 1724), where ϕₜ=Kₜ/(K₀+K₁, . . . +K₇), 0≤t<8.

The transition proportion corresponding to the bands of the attraction measure are denoted ρ₀, ρ₁, ρ₇ (reference 1734), where ρₜ=Lₜ/(L₀+L₁, . . . +L₇), 0≤t<8.

The transition proportion corresponding to the bands of the interest measure are denoted ω₀, ω₁, . . . , ω₇ (reference 1744), where ωₜ=Hₜ/(H₀+H₁, . . . +H₇), 0≤t<8.

Upon detecting an article transition, the indices 1710, 1720, 1730, and 1740 of bands of the similarity, gravitation attraction, and interest levels are determined. Each of the corresponding article-transition scores 1712, 1722, 1732, and 1742 is increased. The corresponding proportions 1714, 1724, 1734, and 1744 of article-transition are recomputed to be considered current merits; the proportion of article transitions for a specific band is a merit of a corresponding affinity measure.

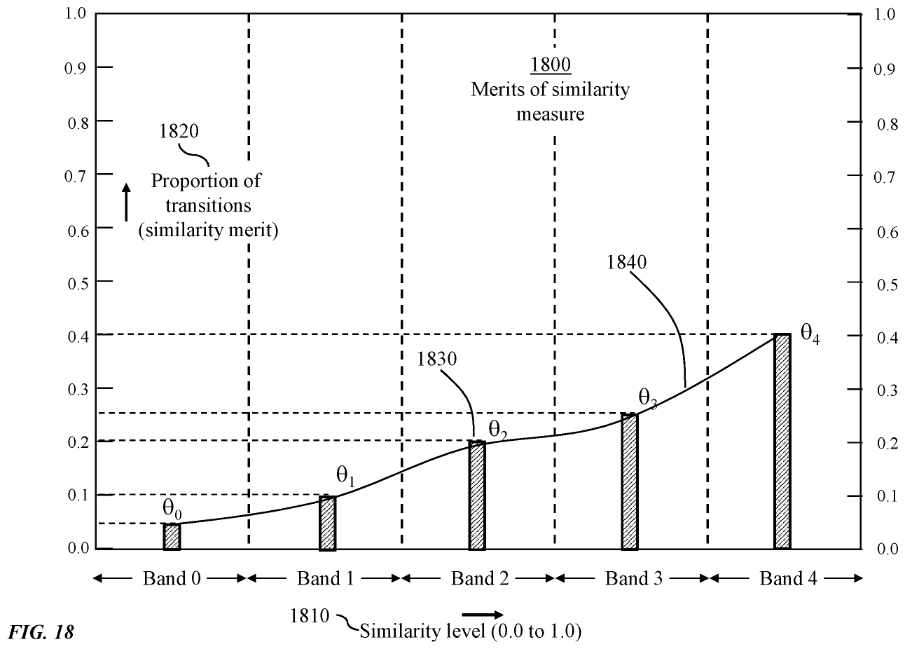

FIG. 18 illustrates merits 1800 of the similarity affinity measure based on the article-transition scores for a case where the values 1810 of the similarity measure are divided into five bands labeled Band-0 to Band-4. An exemplary variation of the proportion 1820 of inter-article transitions with the similarity level is illustrated. The proportions 1830 of inter-article transitions for the five bands (denoted θ₀ to θ₄) are considered similarity merits. An interpolation 1840 of the similarity merit may be used to determine similarity merits corresponding to arbitrary levels of the similarity measure.

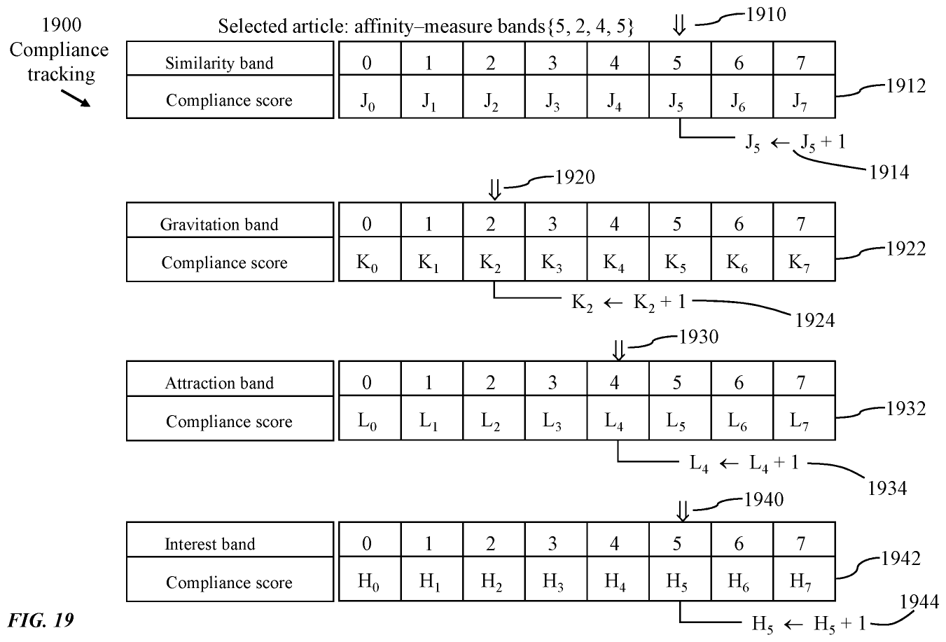

FIG. 19 illustrates compliance-tracking data 1900 for each affinity measure determined according to the process of FIG. 8. The values of each affinity measure (similarity, gravitation, attraction, or interest) are divided into eight bands. In general, the values of each affinity measure may be grouped into a respective number of bands.

The number of bands for each affinity measure is selected to be the same (eight) for ease of illustration. The compliance scores 1912 corresponding to the bands of the similarity measure are denoted J₀, J₁, . . . , J₇. The compliance scores 1922 corresponding to the bands of the gravitation measure are denoted K₀, K₁, . . . , K₇. The compliance scores 1932 corresponding to the bands of the attraction measure are denoted L₀, L₁, . . . , L₇. The compliance scores 1942 corresponding to the bands of the interest measure are denoted H₀, H₁, . . . , H₇.

Upon detecting an article transition following a recommendation, the indices 1910, 1920, 1930, and 1940 of bands of the similarity, gravitation attraction, and interest levels corresponding to the recommendation are determined. Each of the corresponding compliance scores 1912, 1922, 1932, and 1942 is increased. For a transition corresponding to affinity bands 5, 2, 4, and 5, each of compliance scores J₅, K₂, L₄, and H₅ is increased (references 1914, 1924, 1934, and 1944, respectively).

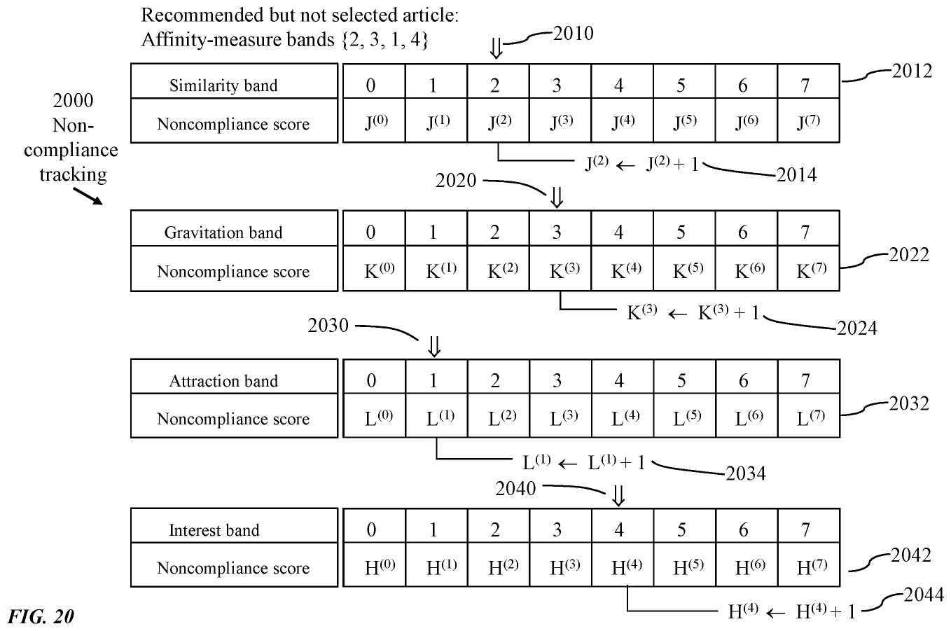

FIG. 20 illustrates noncompliance-tracking data 2000 for each affinity measure. The noncompliance scores 2012 corresponding to the bands of the similarity measure are denoted J⁽⁰⁾, J⁽¹⁾, . . . , J⁽⁷⁾. The noncompliance scores 2022 corresponding to the bands of the gravitation measure are denoted K⁽⁰⁾, K⁽¹⁾, . . . , K⁽⁷⁾. The noncompliance scores 2032 corresponding to the bands of the attraction measure are denoted L⁽⁰⁾, L⁽¹⁾, . . . , L⁽⁷⁾. The compliance scores 1942 corresponding to the bands of the interest measure are denoted H⁽⁰⁾, H⁽¹⁾, . . . , H⁽⁷⁾.

Upon determining that a recommendation has not been followed, the indices 2010, 2020, 2030, and 2040 of bands of the similarity, gravitation attraction, and interest levels corresponding to the recommendation are determined. Each of the corresponding noncompliance scores 2012, 2022, 2032, and 2042 is increased. For noncompliance corresponding to affinity bands 2, 3, 1, and 4, each of noncompliance scores J⁽²⁾, K⁽³⁾, L⁽¹⁾, and H⁽⁴⁾ is increased.

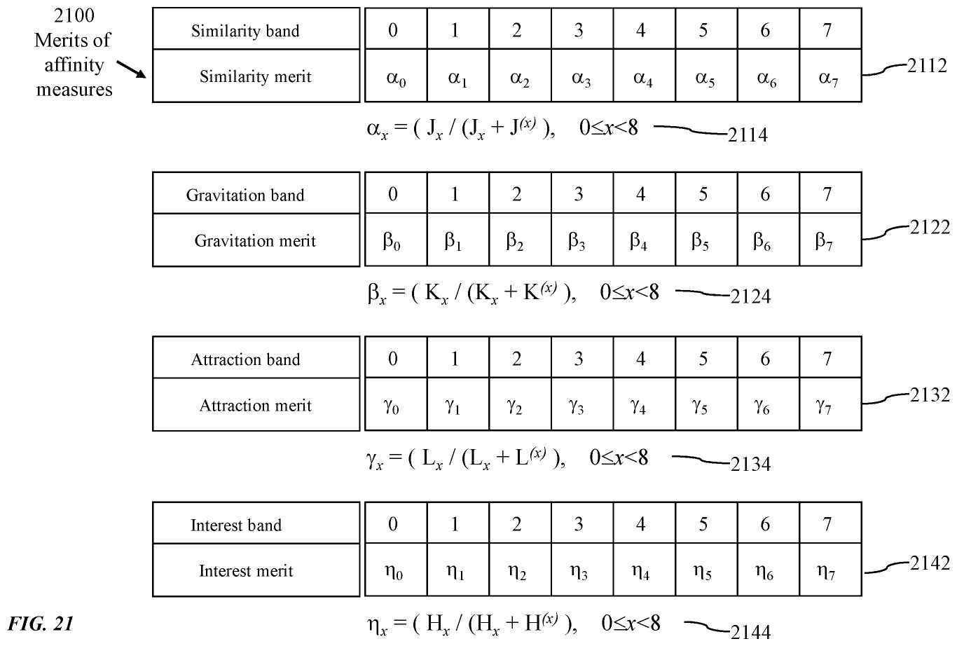

FIG. 21 illustrates merits 2100 for each affinity measure determined according to the process of FIG. 8, based on compliance. The levels of each of the four similarity measures are divided into eight bands. A similarity merit 2112, denoted αₓ, a gravitation merit 2122, denoted βₓ, an attraction merit 2132, denoted γₓ, and an interest merit 2142, denoted ηₓ corresponding to band x, 0≤x<8, are illustrated.

The merits are determined as:

αₓ=Jₓ/(Jₓ+J^{(x)});

βₓ=Kₓ/(Kₓ+K^{(x)});

γₓ=Lₓ/(Lₓ+L^{(x)}); and

ηₓ=Hₓ/(Hₓ+H^{(x)});

references 2114, 2124, 2134, and 2144, respectively.

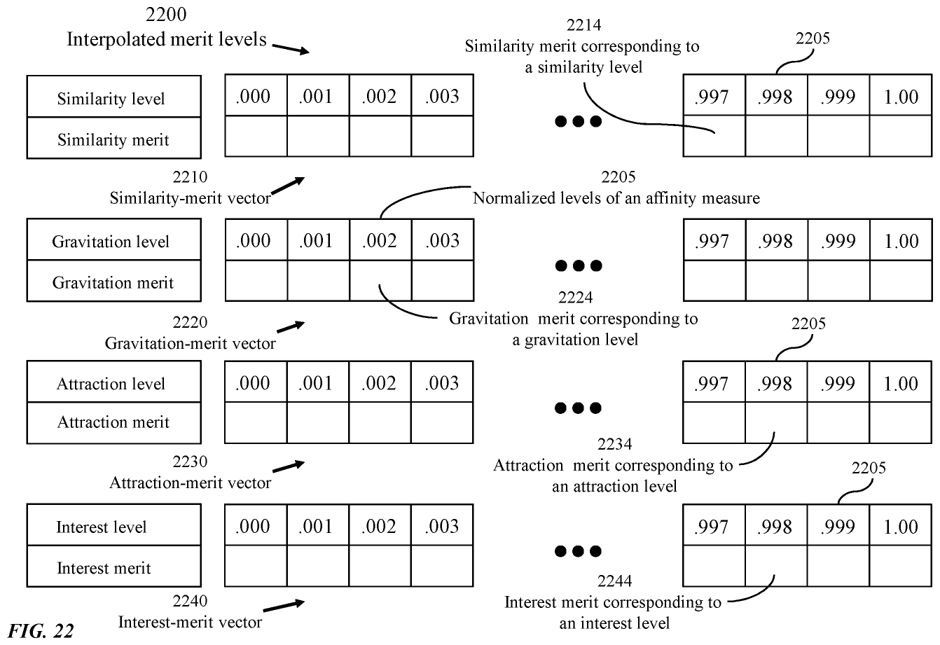

FIG. 22 illustrates interpolated merits 2200 for each affinity measure determined according to the process of FIG. 8. Interpolated merits are determined for a large number, 1000 for example, of normalized affinity-measure levels of 0.0 to 1.0 to produce a similarity-merit vector 2210, a gravitation-merit vector 2220, an attraction-merit vector 2230, and an interest-merit vector 2240. The similarity-merit vector 2210 indicates a similarity merit 2214 corresponding to a rounded similarity level (to nearest integer multiple of 1/1000). The gravitation-merit vector 2220 indicates a gravitation merit 2224 corresponding to a rounded gravitation level. The attraction-merit vector 2230 indicates an attraction merit 2234 corresponding to a rounded attraction level. The interest-merit vector 2240 indicates an interest merit 2244 corresponding to a rounded interest level.

Each of FIGS. 23, 24, 25, and 26 illustrates scores 2320 of recommended articles or selected articles and compliance ratio 2330 for different values of a respective normalized affinity-measure level. The compliance ratio is set to zero if the score of recommended articles is zero. The normalized affinity-measure levels are grouped into five bands of [0.0-0.20), [0.20-0.4), [0.4-0.6), [0.6-0.8), and [0.8-1.0], labelled Band-0 to Band-4, respectively.

FIG. 23 illustrates an exemplary relationship 2300 of compliance-ratio (similarity merit) for different bands of similarity levels indicating score 2320 of recommended articles or selected articles and compliance ratio 2330 for the five bands of similarity levels 2310. For each band, a score 2340 of recommended articles and a corresponding score 2350 of selected articles following recommendation are determined. For Band-x, 0≤x<5, a compliance ratio αₓ (considered a similarity merit 2360) is determined as the ratio of a corresponding score 2350 of selected articles to score 2340 of recommended articles. An interpolation similarity merit function 2370 determines a similarity merit for an arbitrary similarity level

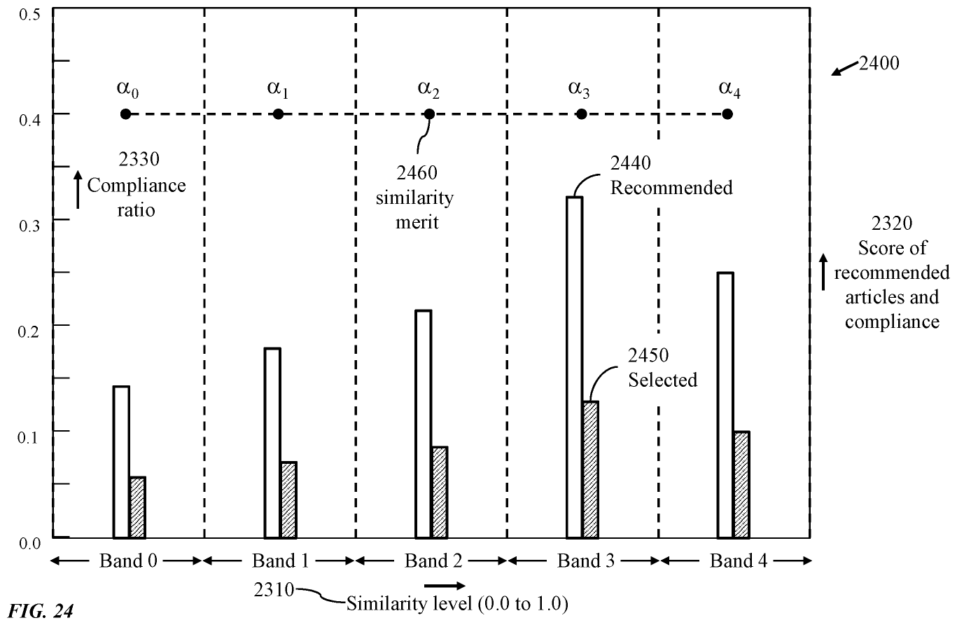

FIG. 24 illustrates a hypothetical case 2400 where compliance-ratio (merit) is independent of similarity levels. The ratio 2460 of a score 2450 of selected articles to corresponding score 2440 of recommended articles is independent of the similarity level. According to the hypothetical case, the similarity measure is insignificant. This case is introduced to emphasize the importance of determining dependence of the compliance ratio on the level of an affinity measure.

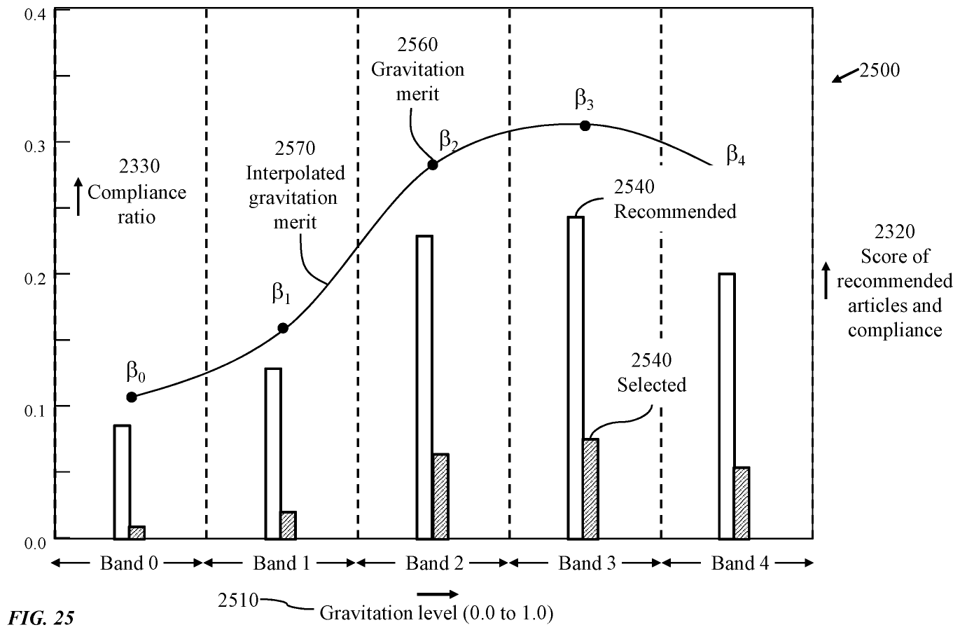

FIG. 25 illustrates an exemplary relationship 2500 of compliance-ratio (gravitation merit) for different bands of gravitation levels indicating score 2320 of recommended articles or selected articles and compliance ratio 2330 for the five bands of gravitation levels 2310. For each band, a score 2540 of recommended articles and a corresponding score 2550 of selected articles following recommendation are determined. For Band-x, 0≤x<5, a compliance ratio βₓ, considered a gravitation merit 2560, is determined as the ratio of a corresponding score 2550 of selected articles to score 2540 of recommended articles. An interpolation gravitation merit function 2570 determines a gravitation merit for an arbitrary gravitation level

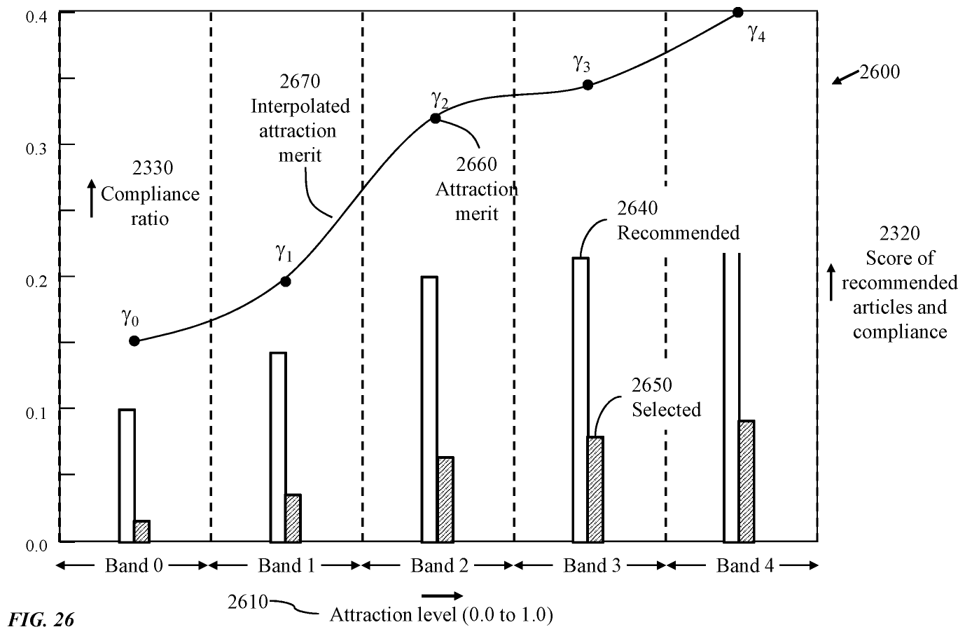

FIG. 26 illustrates an exemplary relationship 2600 of compliance-ratio (attraction merit) for different bands of attraction levels indicating score 2320 of recommended articles or selected articles and compliance ratio 2330 for the five bands of attraction levels 2310. For each band, a score 2640 of recommended articles and a corresponding score 2650 of selected articles following recommendation are determined. For Band-x, 0≤x<5, a compliance ratio γₓ, considered an attraction merit 2660, is determined as the ratio of a corresponding score 2650 of selected articles to score 2640 of recommended articles. An interpolation attraction merit function 2670 determines an attraction merit for an arbitrary gravitation level

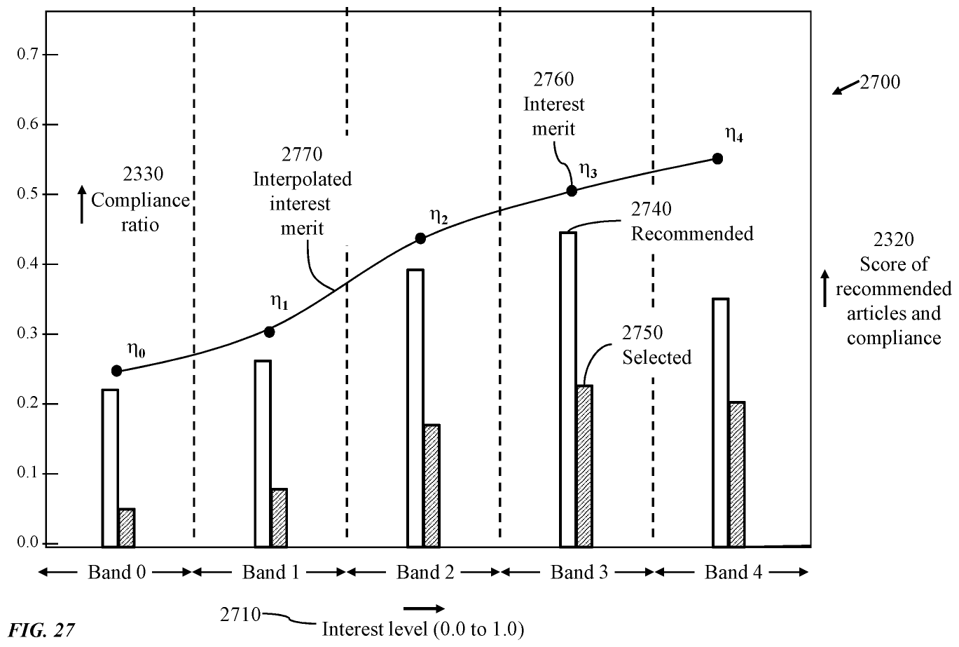

FIG. 27 illustrates an exemplary relationship 2700 of compliance-ratio (interest merit) for different bands of interest levels indicating score 2320 of recommended articles or selected articles and compliance ratio 2330 for the five bands of interest levels 2310. For each band, a score 2740 of recommended articles and a corresponding score 2750 of selected articles following recommendation are determined. For Band-x, 0≤x<5, a compliance ratio ηₓ, considered an interest merit 2760, is determined as the ratio of a corresponding score 2750 of selected articles to score 2740 of recommended articles. An interpolation attraction merit function 2770 determines an attraction merit for an arbitrary gravitation level.

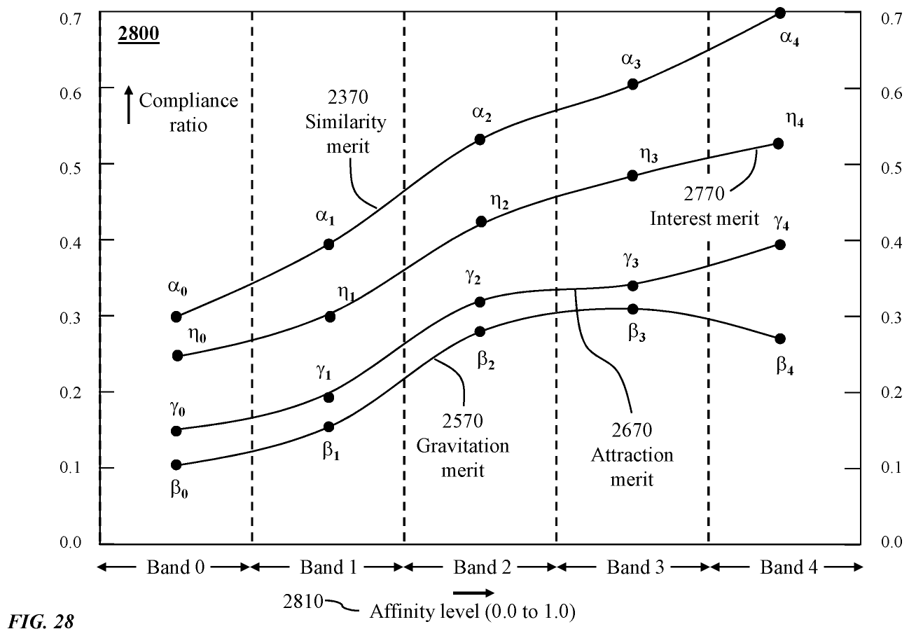

FIG. 28 illustrates a comparison 2800 of compliance ratios (merits) corresponding to different affinity measures for different affinity levels 2810 based on FIGS. 23, 25, 26, and 27. The interpolation functions 2370, 2570, 2670, and 2770 relate similarity merit, gravitation merit, attraction merit, and interest merit to respective affinity levels. According to Method-II, Option-2 (references 140, 160, FIG. 1), the selection of complementing articles is based on merits of affinity measures.

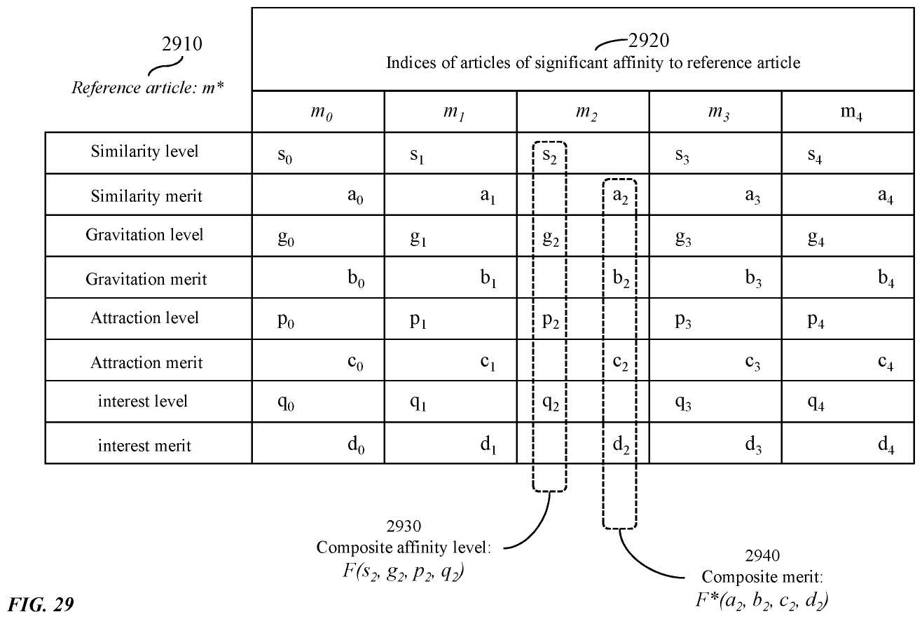

FIG. 29 illustrates affinity merits corresponding to different affinity levels of different affinity measures. For a current article (reference article) 2910, five articles 2920, denoted m₀, m₁, m₂, m₃, and m₄, are selected as candidates for recommendation to a user accessing the current article.

As mentioned earlier, inter-article similarity levels are determined a priori. The inter-article gravitation levels, attraction levels, and interest levels are determined from usage data as described above with reference to FIG. 12.

For the candidate articles m₀, m₁, m₂, m₃, and m₄, the levels of similarity to the current article are denoted s₀, s₁, s₂, s₃, and s₄, respectively, the gravitation levels are denoted g₀, g₁, g₂, g₃, and g₄, respectively, the attraction levels are denoted p₀, p₁, p₂, p₃, and p₄, respectively, and the interest levels are denoted q₀, q₁, q₂, q₃, and q₄, respectively.

The merit of each affinity measure corresponding to a respective affinity-measure level is determined according to transition proportion as illustrated in FIGS. 17 and 18 or according to compliance as illustrated in FIGS. 19 to 21.

Thus, the similarity merits a₀, a₁, a₂, a₃, and a₄, corresponding to similarity levels s₀, s₁, s₂, s₃, and s₄, respectively, are determined according to transition proportion as illustrated in FIGS. 17 and 18 (reference 1714) or according to compliance as illustrated in FIGS. 19 to 21 (reference 2114).

The gravitation merits b₀, b₁, b₂, b₃, and b₄, corresponding to gravitation levels g₀, g₁, g₂, g₃, and g₄, respectively, are determined according to transition proportion (reference 1724) or according to compliance (reference 2124).

The attraction merits c₀, c₁, c₂, c₃, and c₄, corresponding to attraction levels p₀, p₁, p₂, p₃, and p₄, respectively, are determined according to transition proportion (reference 1734) or according to compliance (reference 2134).

The interest merits d₀, d₁, d₂, d₃, and cd₄, corresponding to attraction levels q₀, q₁, q₂, pq₃, and q₄, respectively, are determined according to transition proportion (reference 1744) or according to compliance (reference 2144).

The selection of one of the candidates (m₀, m₁, m₂, m₃, and m₄) may be based on a composite affinity level 2930 determined as a function of affinity levels of the four affinity measures (similarity, gravitation, attraction, and interest). Preferably, the selection may be based on a composite affinity merit 2940 determined as a function of affinity merits of the four affinity measures.

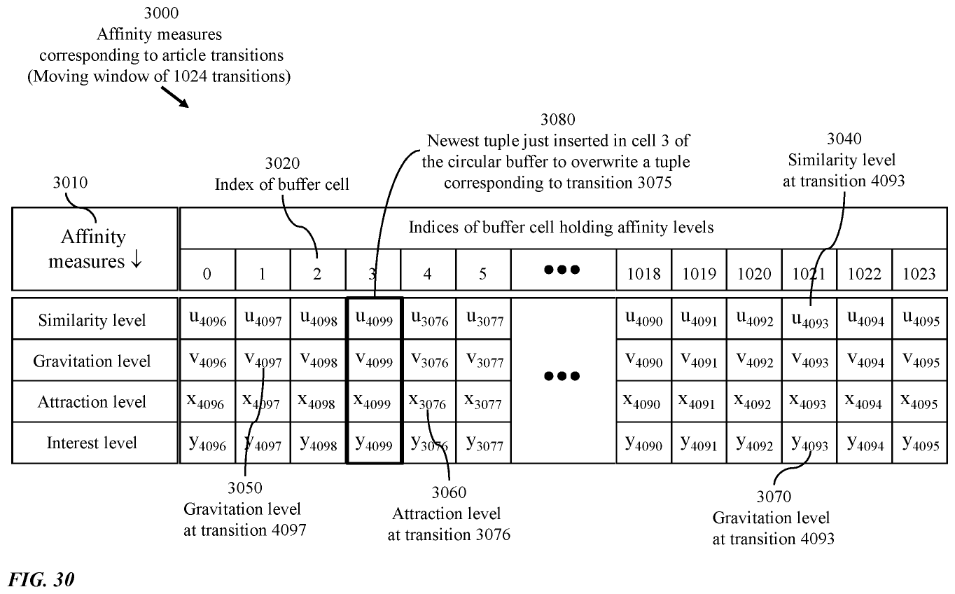

FIG. 30 illustrates affinity measures 3000 stored in buffer cells 3020, of a circular buffer, corresponding to a moving window of 1024 transitions. For each of affinity measures 3010, and for transition τ. τ≥0, a similarity level 3040 (denoted u_{τ}), a gravitation level 3050 (denoted v_{τ}), an attraction level 3060 (denoted x_{τ}), and an interest level 3070 (denoted y_{τ}), are stored in a buffer cell of index τ|modulo N, N being the number of transitions of the moving window. For example, affinity-measures levels at transition 4099 are stored in a cell of index 4099|modulo 1024=3, affinity-measures levels at transition 3076 are stored in a cell of index 3076|modulo 1024=4, and affinity-measures levels at transition 4090 are stored in a cell of index 4090|modulo 1024=1018. Initially, when the transition count does not exceed N, the affinity measures occupy successive buffer cells. As the number of transitions exceeds N, the newest affinity measures overwrite the oldest affinity measures. As illustrated in FIG. 30, the newest affinity measures u₄₀₉₉, v₄₀₉₉, r₄₀₉₉, and y₄₀₉₉ overwrite the oldest affinity measures of the window stored in the buffer cell of index 3075 (reference 3080). The affinity measures at a subsequent transition would overwrite the affinity measures stored in buffer cell 3076.

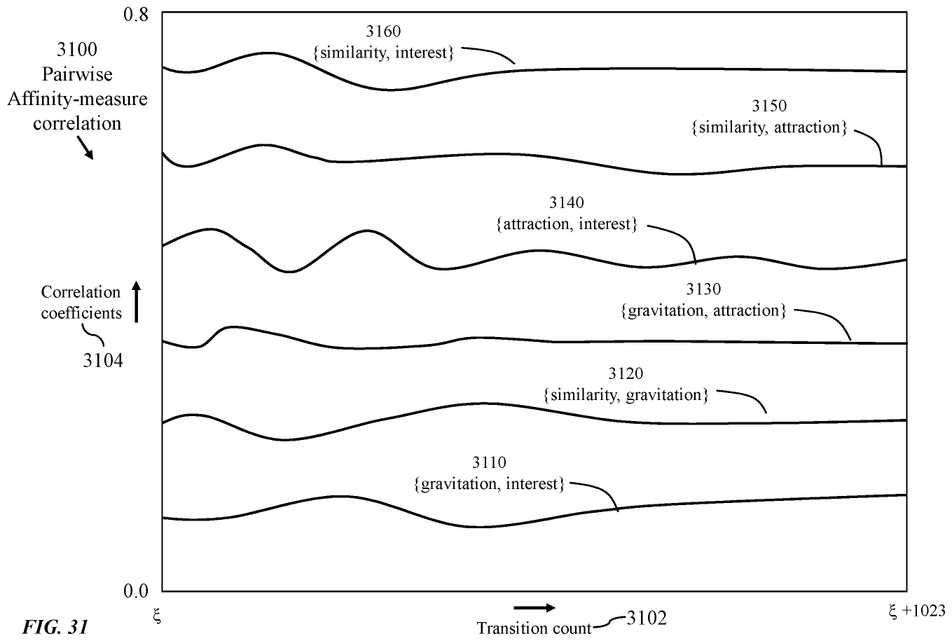

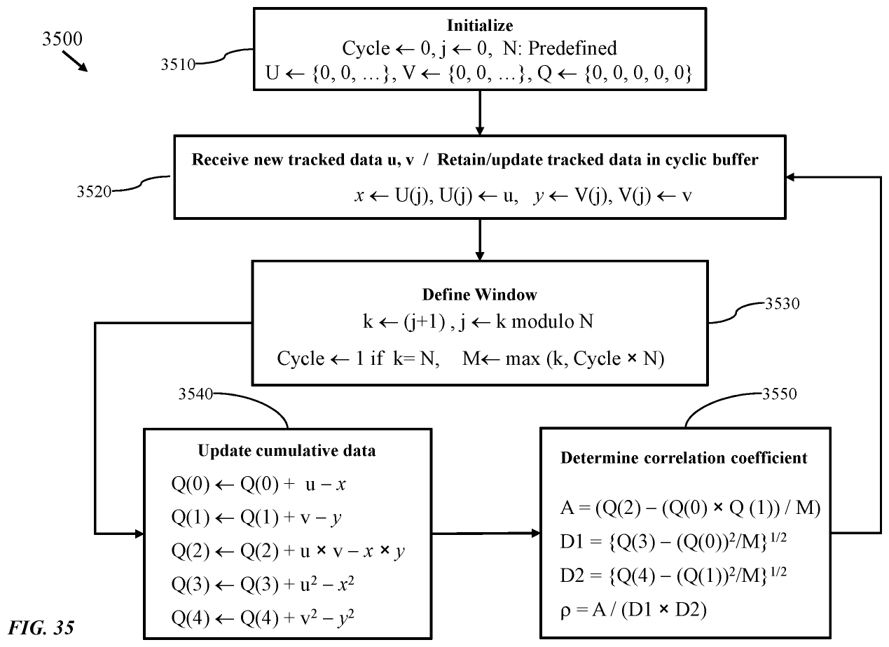

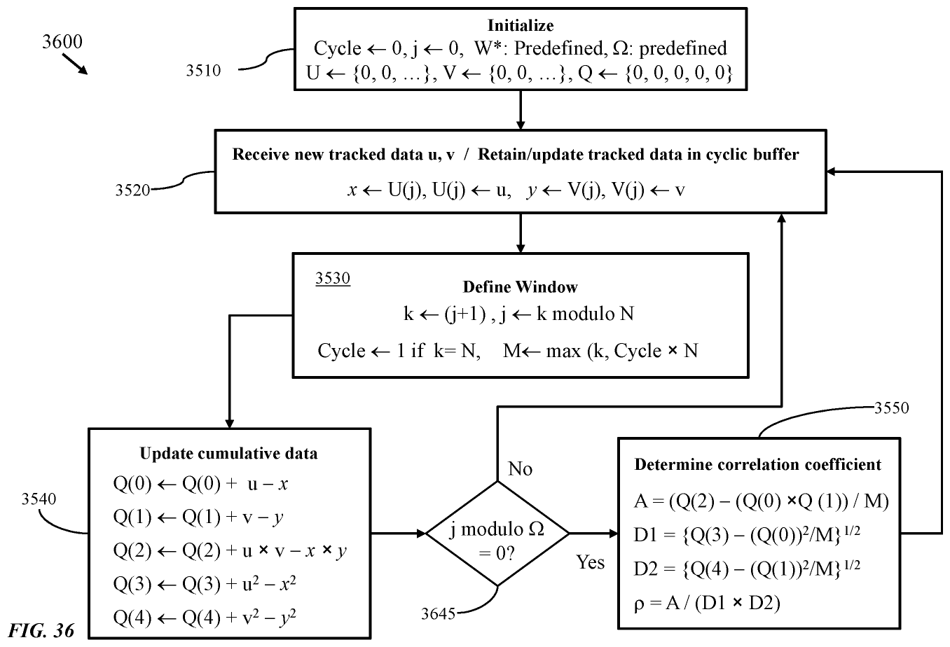

FIG. 31 illustrates pairwise affinity-measures correlation 3100, the affinity measures comprising inter-article similarity, gravitation, attraction, and interest as defined earlier. The correlation coefficient 3104 for each pair of affinity measures is determined, for a sequence of most recent N transitions 3102 which include transition ξ to transition (ξ+N−1), using the stored affinity-measures levels as illustrated in FIG. 30. The correlation coefficient may be determined after transition according to the procedure of FIG. 35 or after each Ω transitions, Ω>1, according to the procedure of FIG. 36. With N=1024, Ω may be selected as 128, leading to 8 samples of the correlation coefficients per affinity-measures pair during a window of N transitions 3102.

The figure illustrates exemplary cases of gravitation-interest correlation 3110; similarity-gravitation correlation 3120; gravitation-attraction correlation 3130; attraction-interest correlation 3140; similarity-attraction correlation 3150; and similarity-interest correlation 3160.

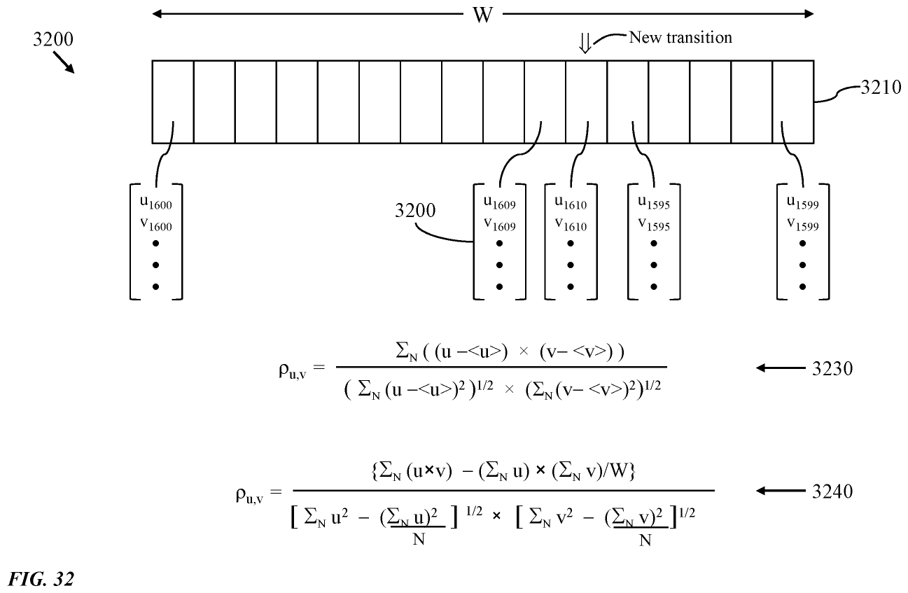

FIG. 32 illustrates a process 3200 of determining cross-correlation ρ_{u,v}, of any two variables, denoted u and v, over a moving window of N article-pair transitions, N>1. An array 3210 of N tuples, each tuple 3220 indicating values of the affinity-measures corresponding to a respective transition is updated following a new transition to overwrite the oldest tuple with values of affinity measures of the new transition. Expression 3230 determines cross-correlation of two variables u and v. Expression 3240, derived from expression 3230, recursively determines cross-correlation of the two variables u and v for values of u and v within a moving window of N tuples.

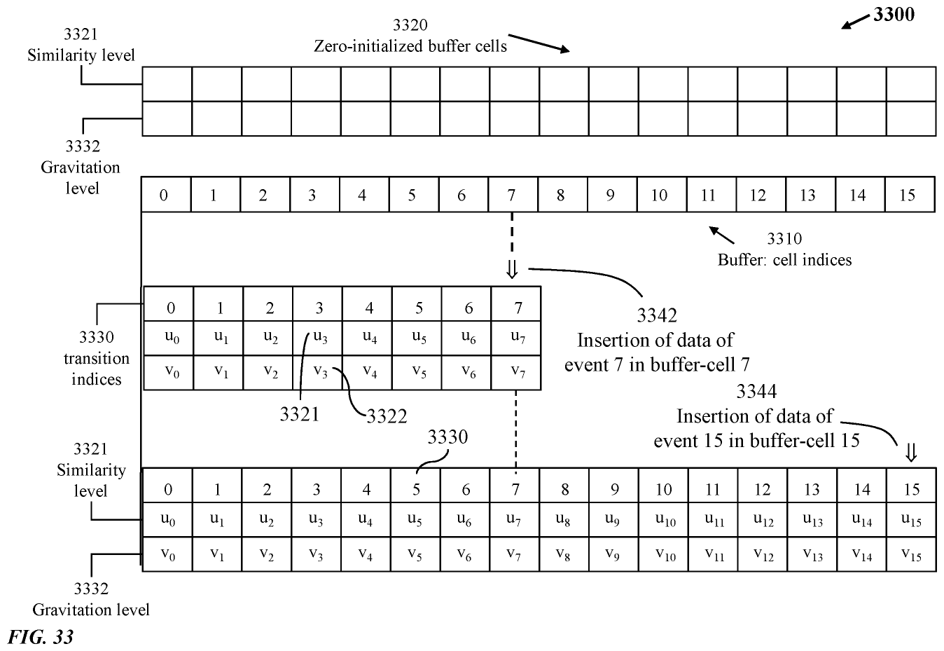

FIG. 33 illustrates a process 3300 of updating data for computing cross-correlation over a transition window of only 16 transitions (N=16, FIG. 32). An array of tuples 3220 is zero initialized. The buffer cells containing the N tuples are indexed (reference 3310) as 0 to (N−1). The transitions are indexed sequentially. With a moving window, a tuple of a transition λ (reference 3330) is stored in a buffer cell of index κ (reference) 3310 where κ=λ|modulo N.

A case of only two affinity measures, the similarity level and the gravitation measure, is illustrated. Thus, each buffer cell stores a similarity level 3321 and a gravitation level 3322. For the first N transitions, a tuple of index λ, 0≤λ<N, is stored in buffer cell λ. As illustrated, the tuple of transition 7 is stored in cell 7 and the tuple of transition 15 is stored in cell 15.

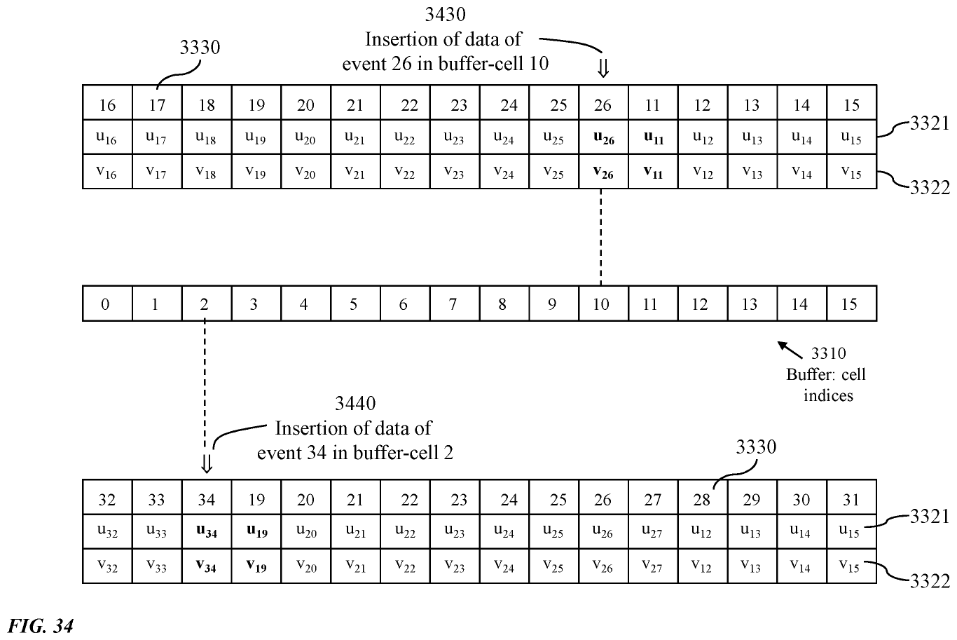

FIG. 34 illustrates process 3400 of updating data for computing cross-correlation as the content of the circular buffer is updated. As illustrated in FIG. 34, the tuple of transition 26 is stored in cell 26|modulo 16, i.e., the cell of index 10, the tuple of transition 34 is stored in cell 34|modulo 16, i.e., the cell of index 2.

FIG. 35 illustrates a method 3500 for fast computation of cross-correlation of any two affinity measures, following each article transition, based on article-transition scores. The process of computing the cross-correlation coefficient is generally computationally intensive. The method of FIG. 35 minimizes the computational effort for the case of a moving window of N variables based on expression 3240.

Process 3510 initializes arrays U and V, used for storing values of a first affinity measure and values of a second affinity measure, to have zero entries. Each of arrays U and V has N entries, N being a number of transitions under consideration. The first affinity measure and second affinity measure may be any pair of the affinity measures under consideration; for example, similarity and attraction. An array Q of five entries holding values of intermediate variables is also initialized to have zero entries.

Process 3520 of receives, stores, and updates records of tracked data of a moving window. Process 3530 defines fill of arrays U and V. Initially, the number of entries within each of arrays U and V may be less than the buffer size of N entries. After N transitions, each of arrays U and V stores the most recent N entries. Process 3540 updates intermediate variables. Process 3550 computes a correlation coefficient.

FIG. 36 illustrates a method 3600 for fast computation of cross-correlation of any two affinity measures, at spaced article transitions, based on article-transition scores. Processes 3510, 3520, 3530, 3540, and 3550 of method 3500 are also applied in method 3600. The main difference between the two methods is the spaced execution of process 3550. Process 3645 activates process 3550 which calculates the correlation coefficient once every S2 transitions, Ω>1. For example, with a window of 1024 transitions (N=1024), the correlation coefficient may be calculated every 16^{th} transition. However, processes 3520, 3530, and 3540 are activated following each transition regardless of the value of Ω.

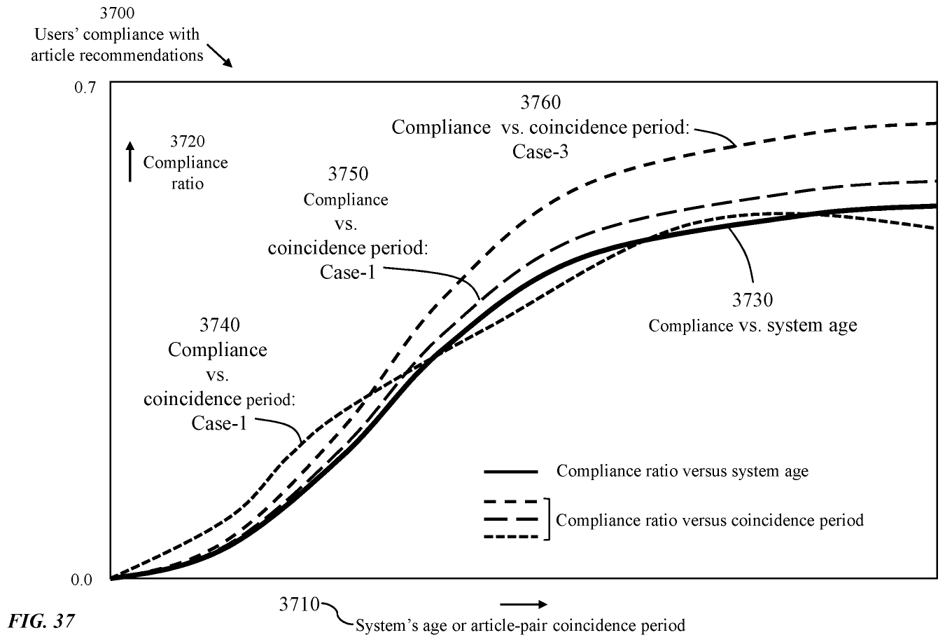

FIG. 37 illustrates dependence 3700 of compliance ratio 3720 on system age or concurrence period 3010 of a recommended article and a reference article. The term “system age” refers to the time period since the start of tracking users. The term “concurrence period” (simultaneity period) refers to a time period during which two articles have been available for user access. For example, if the tracking system is installed at time to, article-X is posted at time t₁ while article-Y is posted at time t₂, t₂≥t₁≥t₀, then at observation time t₃, t₃≥t₂, the concurrence period of article-X and article-Y is (t₃−t₂).

At a given system age T, the mutual concurrence period of several articles may be less than T. Thus, the compliance ratio may be less than a compliance ratio for articles of mutual concurrence period T. FIG. 37 illustrates exemplary compliance ratio versus system age (reference 3730) and three hypothetical cases, 3740, 3750, and 3760, of compliance-ratio variation with concurrence period. For the first hypothetical case, 3740, the compliance ratio at a concurrence period τ is not consistently larger than the compliance ratio at a system age τ, indicating irrelevance of article-pair simultaneity. For the second hypothetical case 3750, the compliance ratio at a concurrence period τ is marginally larger than the compliance ratio at a system age τ over all values of τ. For the third hypothetical case, 3740, the compliance ratio at a concurrence period τ is significantly larger than the compliance ratio at a system age τ over all values of τ, indicating that article-pair simultaneity need be taken into account in the process of determining the gravity, attraction, and interest merits.

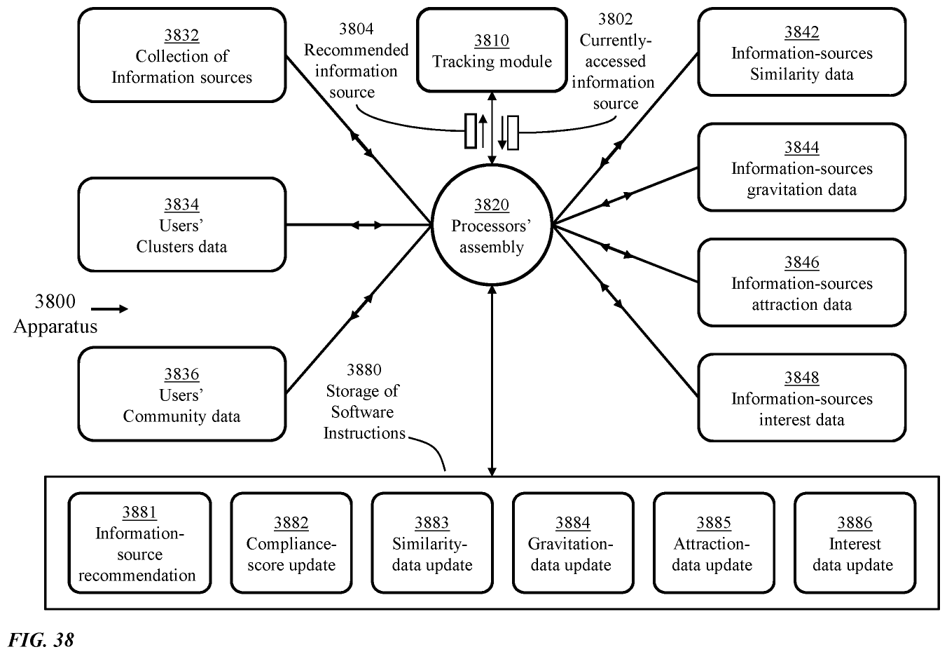

FIG. 38 illustrates an apparatus 3800 for tracking users, identifying a user's access to an article 3802, and recommending to the user a subsequent article 3804 to consider following a user's inspection of the current article 3802. The apparatus comprises a tracking module 3810 coupled to a network interface (not illustrated) for: receiving users' data; communicating recommendations to users; and receiving updated information relevant to articles of interest and users' characterization. The apparatus employs an assembly of processors 3820, memory devices storing basic data relevant to information sources and users, memory devices storing data-analysis results, and memory devices storing software instructions.

A memory device 3832 stores data relevant to information sources. A memory device 3834 stores data relevant to user-cluster association, users' clustering data which may be acquired from external sources or generated within apparatus 3800 using acquired user characterization data and specific software modules. A memory device 3836 stores data relevant to user-communities association. The grouping of users into clusters based on user characteristics, or communities based on user traits, may be performed externally or within apparatus 3800. Memory device 3842 stores article similarity levels which may be determined externally and updated as users access new articles. The similarity data may be generated based on acquired article characteristics. Memory device 3844 stores a gravitation vector for article pairs based on identifiers of articles selected by any user following access to a current article. Memory device 3870 stores an attraction vector for each article for each user cluster based on identifiers of articles selected following each current article. Memory device 3848 stores an interest vector for each article based on identifiers of articles selected following each current article.

Memory devices 3880 store software modules. A memory device 3881 stores a software module containing instructions for determining an appropriate information source (an appropriate article) to follow a currently accessed information source (article). A memory device 3882 stores a software module containing instructions for determining users' compliance scores. Memory devices 3883, 3884, 3885, and 3886 store software modules for updating mutual similarity levels, gravitation levels, attraction levels, and interest levels, respectively, of information sources or articles.

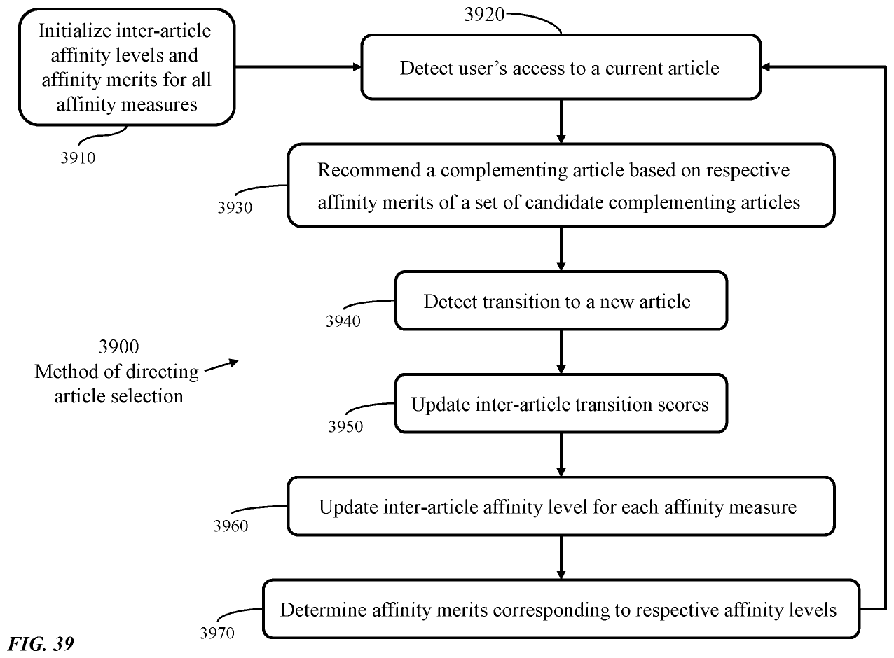

FIG. 39 illustrates a method 3900 of directing article selection. Process 3910 initializes an array of affinity-level bands for each affinity measure. An array of affinity merits corresponding to different bands of affinity levels for each affinity measure is initialized to equal a corresponding array of affinity-level bands. Process 3920 detects a user's access to a current article. Process 3930 recommends a complementing article to follow the current article, based on respective affinity merits of a set of candidate complementing articles, and communicates relevant information to the user. Process 3940 detects the user's access to a new article, within a predefined time interval, if any. Process 3950 updates inter-article transition scores. Process 3960 updates inter-article affinity level for each affinity measure. Process 3970 determines affinity merits corresponding to respective affinity levels

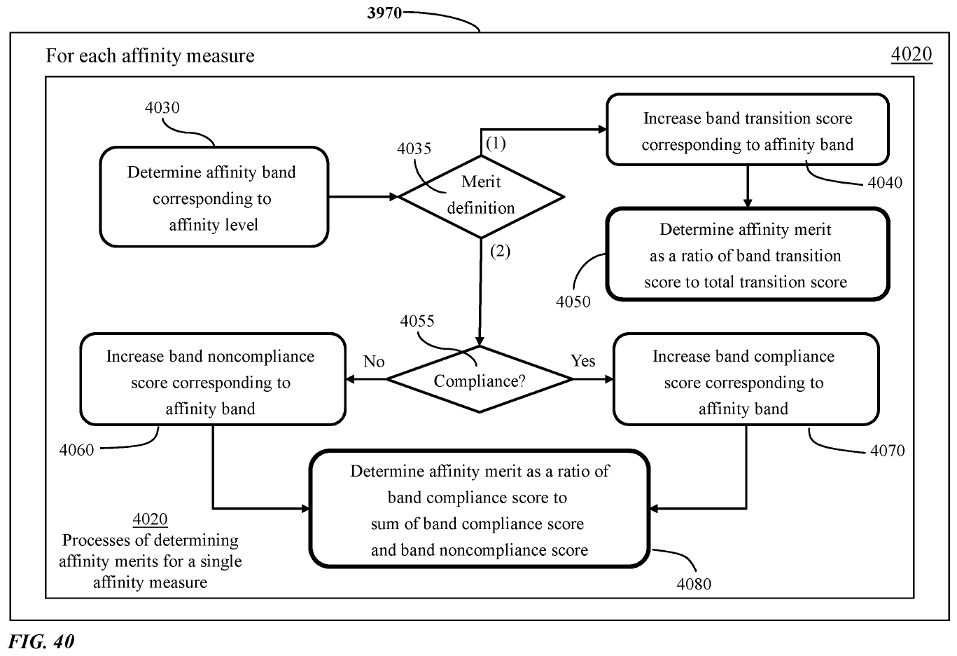

FIG. 40 details process 3970 of determining affinity merits corresponding to respective affinity levels. Process 3970 performs processes 4020, which determine affinity merits for a single affinity measure, for each of the four affinity measures (similarity, gravity, attraction, and interest). Processes 4020 include processes 4030 to 4080. Process 4035 acquires a prescribed selection of one of two methods which are based on different definitions of affinity merit. Processes 4040 and 4050 correspond to a first method (FIGS. 17-18) while processes 4055, 4060, 4070, and 4080 correspond to a second method (FIGS. 19-28).

Process 4040 increases transition score for the specific affinity band determined in process 4030. Process 4050 determines an affinity merit corresponding to the specific affinity band as a ratio of the transition score of the specific affinity band to the total transition score. Process 4055 determines compliance, or otherwise, with a recommendation of process 3930. Process 4060 is executed if the new article (process 3940) is not the recommended complementing article. Process 4070 is executed if the new article is the complementing article. Process 4060 increases a noncompliance score corresponding to the specific affinity band while Process 4070 increases a compliance score corresponding to the specific affinity band. Process 4080 determines an affinity merit corresponding to the specific affinity band as a ratio of the compliance score to the sum of compliance score and noncompliance score.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of directing information access comprising:
executing instructions causing a hardware processor to perform processes of:
acquiring inter-source affinity levels of a set of predefined affinity measures for each pair of sources of information of a set of sources of information;
initializing affinity merits of said each pair to equal respective affinity levels;
detecting access of a user of an information dissemination network to a current source of information;
recommending to the user a complementing source of information based on affinity merits corresponding to specific affinity levels of the current source to a set of sources of information;
detecting access transition of the user to a new source of information;
accumulating inter-source transition scores;
determining new affinity levels of the current source to the new source for each said affinity measure according to respective transition scores; and
updating affinity merits for each said affinity measure according to said respective transition scores.

2. The method of claim 1 further comprising:
dividing the inter-source affinity levels corresponding to each affinity measure of the set of affinity measures into a respective number of affinity-level bands;
grouping said inter-source transition scores according to respective affinity-level bands; and
determining an affinity merit corresponding to each affinity-level band as a ratio of a respective transition score to total transition score.

3. The method of claim 1 further comprising:
dividing the inter-source affinity levels corresponding to each affinity measure of the set of affinity measures into a respective number of affinity-level bands; and
for each affinity measure and a respective affinity-level band:
increasing a recommendation score;
increasing a compliance score subject to a determination that the new source is the recommended source;
determining an affinity merit as a ratio of a respective compliance score to a respective recommendation score.

4. The method of claim 2 further comprising:
determining, for each affinity measure, an interpolating function for determining an affinity merit corresponding to an arbitrary affinity level, said interpolating function based on affinity merits corresponding to affinity-level bands; and
determining said affinity merit corresponding to said specific affinity levels according to the interpolating function.
